(19) United States
(12) Patent Application Publication
(10) Pub. No.: US 2025/0297079 A1
(43) Pub. Date: Sep. 25, 2025

(54) PLASTIC WASTE UPCYCLING USING PHOTOCATALYTIC REACTIONS

(71) Applicants: Yimin A. WU, Waterloo (CA); Wei WEI, Waterloo (CA); Cheng DU, Beijing (CN)

(72) Inventors: Yimin A. WU, Waterloo (CA); Wei WEI, Waterloo (CA); Cheng DU, Beijing (CN)

(21) Appl. No.: 19/089,933

(22) Filed: Mar. 25, 2025

Related U.S. Application Data
(60) Provisional application No. 63/569,605, filed on Mar. 25, 2024.

(51) Int. Cl. C08J 11/16; B01J 23/745; B01J 27/24; B01J 35/45; B01J 37/04; B01J 37/08

(52) U.S. Cl. CPC C08J 11/16; B01J 23/745; B01J 27/24; B01J 35/45; B01J 37/04; B01J 37/084; B01J 37/088; C08J 2323/06; C08J 2323/12; C08J 2367/02

(57) ABSTRACT

An example method of upcycling plastic waste includes: providing plastic waste to be upcycled; applying an iron (Fe) single-atom catalyst to the plastic waste to be upcycled; and catalyzing, using the Fe single-atom catalyst, a reaction to upcycle the plastic waste to produce acetic acid. The Fe single-atom catalyst may include Fe atoms embedded on a graphitic carbon nitride (C₃N₄) support framework (Fe@C₃N₄ SAC). The Fe@C₃N₄ SAC may operate using a cascade photocatalytic reaction mechanism coupling Fenton and CO₂ reduction reactions.

### FIELD

The specification relates generally to handling plastic waste, and more particularly to plastic waste upcycling using photocatalytic reactions.

### BACKGROUND

Since the 1950s, the plastics industry has rapidly developed and contributed significantly to technological and economic advances. Plastic wastes possess a very long self-degradation cycle in nature (ca. 250-500 years) due to their strong chemical inertness, causing the worldwide “white pollution” problem. Extensive research shows that major ecosystems on Earth have been contaminated by plastic waste, including microplastics, raising concerns about its potential threats to terrestrial and marine life and human health. In particular, the appearance of plastic waste in food and drinking water supplies (e.g., seafood, tea, vegetables) is a significant worry. Microplastics have even been found in human placenta and infant formula. The COVID-19 pandemic has further intensified pressure on an already significant global plastic waste problem by increasing the amount of used disposable plastic medical supplies, including syringes, gloves, and other personal protective equipment. Plastic waste imposes a threat to the environment, ecosystems, and human health, in part because of inefficient methods and low utilization efficiency of plastics recycling and upcycling in industry.

### SUMMARY

According to an aspect of the present specification, a method for plastic waste upcycling includes: providing plastic waste to be upcycled; applying an iron (Fe) single-atom catalyst to the plastic waste to be upcycled; and catalyzing, using the Fe single-atom catalyst, a reaction to upcycle the plastic waste to produce acetic acid.

According to another aspect of the present specification, a catalyst to upcycle plastic waste in a photocatalytic reaction to produce acetic acid, includes iron (Fe) atoms embedded on a graphitic carbon nitride (C₃N₄) support framework (Fe@C₃N₄ SAC).

### BRIEF DESCRIPTION OF DRAWINGS

The patent or application file contains at least one drawing executed in color. Copies of this patent or patent application publication with color drawing(s) will be provided by the Office upon request and payment of the necessary fee.

Implementations are described with reference to the following figures, in which:

FIG. 1 depicts a flowchart of an example method of plastic waste upcycling.

FIG. 2 depicts a schematic diagram of the reaction mechanism in the method of FIG. 1.

FIG. 3 depicts photocatalytic activation of Fe@C₃N₄ SAC for PET degradation in the presence of different scavengers.

FIG. 4 depicts the yield of acetic acid with CO₂ flowed into the reactor.

FIG. 5 depicts the yield of acetic acid during the photocatalytic-induced degradation of pure PET with C₃N₄ or Fe@C₃N₄ SAC.

FIG. 6 depicts yield over time with excess H₂O₂ supplied at the outset.

FIG. 7 depicts the results of plastic upcycling of PET, PE, and PP using an uncovered reactor with Fe@C₃N₄ SAC or C₃N₄.

FIG. 8 depicts the effect of the particle size of plastics with the use of the Fe@C₃N₄ SAC photocatalysts.

FIG. 9 depicts the yield of acetic acid from PP, PET and PE under the Fe@C₃N₄ SAC/H₂O₂/Vis System

FIG. 10 depicts the effect of light trapping in the reactor for commodity PET with 30% glass fibers and pure PET upcycling to acetic acid using the Fe@C₃N₄ SAC photocatalyst.

FIG. 11 depicts the effect of light trapping in the reactor for PE upcycling to acetic acid using the Fe@C₃N₄ SAC photocatalyst.

FIG. 12 depicts the effect of light trapping in the reactor for PP upcycling to acetic acid using the Fe@C₃N₄ SAC photocatalyst.

FIG. 13 depicts a schematic diagram of the synthesis procedure of graphitic carbon nitride (C₃N₄) and Fe@C₃N₄ SAC.

FIGS. 14A and 14B depict scanning electron microscope (SEM) images showing the morphology of the C₃N₄ nanosheet and the Fe@C₃N₄ SAC, respectively.

FIG. 15 depicts a probe aberration-corrected high-angle annular dark field scanning transmission electron microscopy (AC-HAADF-STEM) image of the Fe@C₃N₄ SAC.

FIGS. 16A-D depict scanning transmission electron microscopy energy dispersive X-ray spectroscopy (STEM-EDX) elemental mapping images of Fe@C₃N₄ SAC.

FIG. 17 depicts X-ray powder diffraction (XRD) analysis of C₃N₄ and Fe@C₃N₄ SAC.

FIG. 18 depicts a high resolution of C 1s XPS spectra of (a) C₃N₄ and (b) Fe@C₃N₄ SAC.

FIG. 19 depicts high-resolution N 1s XPS spectra of (a) C₃N₄ and (b) Fe@C₃N₄ SAC.

FIG. 20 depicts high-resolution Fe 2p XPS spectra of (a) Fe@C₃N₄ SAC before irradiation and (b) Fe@C₃N₄ SAC after irradiation.

FIG. 21 depicts the Raman spectroscopy of C₃N₄ and Fe@C₃N₄ SAC.

FIG. 22 depicts the UV-Vis absorption spectroscopy of C₃N₄ and Fe@C₃N₄ SAC.

FIG. 23 depicts the Fe K-edge X-ray absorption near-edge structure (XANES) spectra of Fe@C₃N₄ SAC and Fe foil.

FIG. 24 shows the Fourier-transformed (FT) curves at R space for Fe@C₃N₄ SAC and Fe foil.

FIGS. 25A and 25B depict (A) synchrotron X-ray spectroscopy characterization of the Fe@C₃N₄ SAC photocatalyst and the corresponding EXAFS R space fitting result of the first coordination shell for (a) Fe@C₃N₄ SAC and (b) Fe foil; and (B) synchrotron X-ray spectroscopy characterization of the Fe@C₃N₄ SAC photocatalyst from SXRMB and the corresponding EXAFS R space fitting result of the first coordination shell for (a) Fe@C₃N₄ SAC and (b) Fe foil.

FIGS. 26A and 26B depict the Wavelet transform (WT) of EXAFS at Fe K-edge for Fe@C₃N₄ SAC and Fe foil as a reference.

FIG. 27 depicts operando UV-Vis spectra of (a) C₃N₄ and (b) Fe@C₃N₄ SAC during photocatalytic upcycling processes and operando electron paramagnetic resonance spectroscopy (EPR) spectra of the DMPO-*OH over (c) C₃N₄ and (d) Fe@C₃N₄ SAC solutions with/without visible light irradiation.

FIG. 28A depicts operando Fourier transform infrared spectroscopy (FTIR) spectra of C₃N₄ and Fe@C₃N₄ SAC and operando synchrotron hard X-ray absorption spectroscopy of Fe@C₃N₄ SAC during the cascade photocatalysis from Hard X-ray MicroAnalysis (HXMA). FIG. 28B depicts the Fe K-edge XANES and FIG. 28C depicts the corresponding EXAFS R space results.

FIG. 29 shows CO₂ reduction reaction pathway for Fe@C₃N₄ SAC and C₃N₄ with their reaction pathway.

FIG. 30 shows the calculated Gibbs free energy diagram of the CO₂ reduction reaction pathway for Fe@C₃N₄ SAC and C₃N₄.

FIGS. 31A and 31B shows the projected density of states (PDOS) of Fe and CO₂ before (FIG. 31A) and after (FIG. 31B) the adsorption of CO₂ on the Fe1 site of Fe@C₃N₄ SAC.

FIG. 32 depicts in situ synchrotron X-ray absorption spectroscopy of Fe@C₃N₄ SAC during the cascade photocatalysis from Hard X-ray MicroAnalysis (HXMA).

FIG. 33 depicts in situ synchrotron X-ray absorption spectroscopy of Fe@C₃N₄ SAC during the cascade photocatalysis from Hard X-ray MicroAnalysis (HXMA).

FIG. 34 depicts (a) the atomic configurations of Fe@C₃N₄ SAC and (b) its electronic potential distribution.

FIG. 35 depicts the thermodynamically stable structure of (a) C₃N₄ and (b) Fe@C₃N₄ SAC with carbon vacancy.

FIG. 36 depicts the adsorption model of CO₂ on (a) C₃N₄ and (b) Fe@C₃N₄ SAC.

FIG. 37 depicts (a) Atomic configurations of C₃N₄ and (b) its electronic potential distribution. Projected density of states (PDOS) of Fe and CO₂ (c) before and (d) after the adsorption of CO₂ on the Fe1 site of C₃N₄.

FIG. 38 shows the calculated Gibbs free energy diagram of the Fenton reaction pathway.

FIG. 39 shows the Fenton reaction pathway of (a) Fe@C₃N₄ SAC and (b) C₃N₄.

FIG. 40 shows the calculated reaction pathway of C₃N₄ for CO₂ reduction reaction.

FIG. 41 shows (a) the calculated Gibbs free energy diagram of CO₂ reduction reaction pathway for Fe@C₃N₄ and C₃N₄ with (b-c) their reaction pathway.

FIG. 42 shows (a) Representative NMR spectrum for acetic acid. (b) The standard curve of acetic acid.

### DETAILED DESCRIPTION

Landfill and incineration are the most used traditional commercialized methods for plastic waste treatment. Mechanical recycling is another traditional method, which can recycle plastic waste by mechanically grinding the plastics into secondary raw materials, but this approach is considered a downgrading recycle method and still leads to plastic waste production. Thermo-catalytic pyrolysis of plastic waste into valuable carbonaceous fuels and pyrolysis of plastics at extreme high temperature have also been reported, but the harsh conditions (high temperature, high energy input, high pressure, inert atmosphere, and costly metal complex catalysts) limits their practical applications. Although these methods seem to work, they cannot eliminate the plastic waste and may even cause serious environmental issues, such as plastic debris contamination of groundwater from landfills, and release of toxic and greenhouse (CO₂) gases from incineration or thermo-chemical methods.

It is possible to process plastic using a two-step photo-reforming strategy to transform alkaline heat pretreated hydrolysed plastics products into a variety of small carbonaceous molecules under room temperature, and producing H₂ at the same time. However, the alkaline heat treatment cost extra energy, and the strongly alkaline solution used in the hydrolytic process may inevitably cause adverse environmental effects. This two-step photo-reforming strategy causes plastic degradation by alkali hydrolysis. The solar energy is just used to transform the hydrolysed plastics products, rather than the plastic itself. Thus, the energy efficiency of this two-step process is low.

To better utilize the solar energy and avoid large amounts of environmentally unfriendly alkaline solution, a one-step process to upcycle plastic using solar energy would be advantageous. According to one example, a Nb₂O₅ atomic layer photocatalyst was developed to transform plastic waste into value-added products (i.e., products which have additional and/or different functions or uses beyond the use of the original product). But the very low production yield and high cost of Nb₂O₅ atomic layers significantly limits the scaled-up industrial application of this method. In another example, the potential of non-noble-metal-based heterogeneous catalysts for hydrogenation reactions was demonstrated, which offer detailed insights into alternative hydrogen sources under mild conditions, presenting a potential pathway for catalytic applications. However, such heterogeneous catalysts are based on thermal catalysis, requiring additional energy input.

Given this, it would be beneficial to develop innovative solutions to convert plastic waste into value-added chemicals with high production yield under ambient conditions using a low-cost photocatalyst without CO₂ gas emissions to the environment.

In nature, microorganisms such as fungi provide many degradation methods for polymerized wood such as lignin and cellulose. This is achieved mainly by the use of peroxidases to break the bonds between various lignin units. Among them, Phanerochaete chrysosporium is able to produce lignin-degrading enzymes such as lignin peroxidase (LiP) and manganese peroxidase (MnP). LIP and MnP will attack lignin nonspecifically triggered by H₂O₂, thereby achieve primary degradation of lignin. During this Fenton-like process, no CO₂ was released from Phanerochaete chrysosporium.

As described herein, a iron (Fe) single atoms are provided or embedded on a graphitic carbon nitride (C₃N₄) support framework to form a single atom catalyst (SAC), referred to herein as Fe@C₃N₄ SAC. In particular, the Fe@C₃N₄ SAC serves as a cascade photocatalyst by coupling Fenton and CO₂ reduction reactions. This photocatalyst can produce value-added acetic acid from various plastic waste, such as PET, PP, and PE.

In particular, similar to the process undertaken by the bacteria Phanerochaete chrysosporium, hydrogen peroxide (H₂O₂) is first photo catalytically converted into a hydroxyl radical (*OH) over an Fe single atom active site on the Fe@C₃N₄ SAC. Subsequently, the produced hydroxyl radical oxidizes plastics into CO₂ intermediates, which are then further reduced into acetic acid on the Fe@C₃N₄ SAC. This reaction mechanism was confirmed by in situ synchrotron X-ray absorption spectroscopy (XAS), in-situ Fourier transform infrared (FTIR) spectroscopy, in situ electron paramagnetic resonance (EPR), in situ UV-vis-absorption spectroscopy, Raman spectroscopy, and aberration-corrected scanning transmission electron microscopy, nuclear magnetic resonance spectroscopy, and density functional theory calculations, as will be further described herein.

The Fe@C₃N₄ SAC can avoid the common problem of metal leaching and massive sludge generation by the traditional Fenton reaction, since the amount of Fe atoms are well bonded on the C₃N₄ support framework. With this presently described design, the acetic acid production in the one-step photocatalytic system reached an activity of 10.5 mg h⁻¹ g_{cat}⁻¹ from PE, 2.96 mg h⁻¹ g_{cat}⁻¹ from PET, and 1.7 mg h⁻¹ g_{cat}⁻¹ from PP under AM1.5G irradiation. It was also found that the production yield can be boosted by sealing the reactor with Aluminum (Al) foil to enhance photon transport and utilization. Acetic acid production in the same photocatalytic system with the reactor covered by Al foil is 12.7 mg h⁻¹ g_{cat}⁻¹ from PE, 5.4 mg h⁻¹ g_{cat}⁻¹ from PET, and 5.3 mg h⁻¹ g_{cat}⁻¹ from PP.

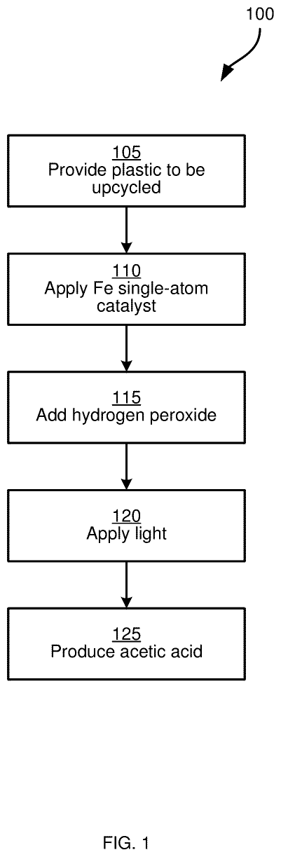

FIG. 1 depicts a flowchart of an example method 100 for plastic waste upcycling. In particular, the method 100 employs cascade photocatalysis using the Fe@C₃N₄ SAC.

At block 105, the plastic waste to be upcycled is provided, for example by adding the plastic waste to a reaction chamber. In some examples, the reaction chamber may be an enclosed vessel or the like, while in other examples, the reaction chamber may be a pond or other suitable reservoir. Different types of plastic waste may upcycled using the presently described method, such as, but not limited to polyethylene terephthalate (PET), polypropylene (PP) and polyethylene (PE), commodity PET with 30% glass fibers, combinations of the above, and the like.

In particular, with the presently described method, the plastic waste may be added to the reaction chamber to be upcycled without pre-treatment as with the two-step processes.

At block 110, the Fe single-atom catalyst is applied to the plastic waste to be upcycled. In particular, in the present example, the Fe@C₃N₄ SAC is added to the reaction chamber with the plastic waste to be upcycled. In particular, the Fe@C₃N₄ SAC may be dispersed in deionized water, for example in a concentration of between 5 mg and 10 mg of catalyst per 30 mL of water. Preferably, the catalyst may be dissolved in an amount of 8 mg per 30 mL of water. The solution may be stirred, for example with a magnetic stirrer to disperse the catalyst and then the solution may be added to the reaction chamber.

In some examples, the pH of the reaction chamber may be adjusted until the pH reaches about 3. For example, an acid such as H₂SO₄ may be added to adjust the pH.

At block 115, hydrogen peroxide may be added to the reaction chamber. For example, the hydrogen peroxide may be added to the reaction chamber in an amount of about 2 mL relative to the 30 mL solution of the Fe@C₃N₄ SAC. In some examples, additional hydrogen peroxide may be added according to the amount of plastic waste to be upcycled.

Preferably, blocks 105-115 may be performed with the reactor or reaction chamber being shielded from light irradiation to ensure that the adsorption equilibrium is established.

At block 120, light is applied to the reaction chamber or reactor. For example, the light may be applied from an electric light source, such as a lamp or the like, or from natural sunlight. Where the light is applied from a light source, in some examples, the light source may be equipped with an AM 1.5 G filter to simulate natural sunlight to be applied to the reaction chamber. In other examples, other light intensities may be applied.

Optionally, in some examples, particularly when the reaction chamber or reactor is able to be enclosed, the reactor may be sealed, for example by wrapping the reactor with aluminum foil or the like. In particular, the reaction chamber may preferably be sealed with a reflective material to enhance photon transport and utilization efficiency within the reaction chamber.

Further, in some examples, during the photoreaction process, the reaction system may be under continuous magnetic stirring, and the temperature of the reaction chamber may be controlled at 298±0.2 K, for example by a recirculating cooling water system during irradiation.

At block 125, acetic acid is produced by the photocatalysis reaction as induced by the Fe@C₃N₄ SAC.

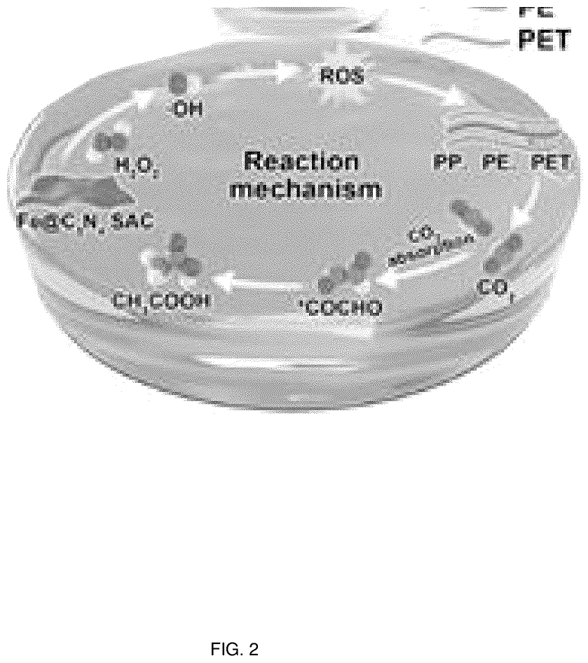

In accordance with the analysis performed during experimental testing, the method 100 operates via a reaction mechanism 200 depicted in FIG. 2.

During the photocatalytic reaction, hydroxyl radicals (*OH) would form and subsequently attack and oxidize plastics, such as polyethylene terephthalate (PET), polypropylene (PP), and polyethylene (PE), into CO₂ intermediates. These CO₂ intermediates were then photo-reduced to acetic acid on the same catalyst via cascade photocatalysis.

In the process, plastic is converted to CO₂ and immediately produces *COCHO, which is eventually converted to acetic acid. In particular, during the experimental testing, the photocatalytic activities of Fe@C₃N₄ SAC and C₃N₄ were evaluated by the upcycling of plastic, such as polyethylene terephthalate (PET), under simulated conditions of one sun radiation and atmospheric pressure. PET, typical commercial plastics for drinking bottles, is known to exhibit relatively stable physical and chemical properties under visible light irradiation without the involvement of a photocatalyst.

In the experimental setup, the photocatalytic activities of catalysts were mainly evaluated by the upcycling of different plastics (i.e., polyethylene terephthalate (PET), polypropylene (PP) and polyethylene (PE), commodity PET with 30% glass fibers) in a simulated natural environment with AM1.5G irradiation from a solar simulator. In particular, the experimental setup was modelled after the method 100 described above.

In a typical experiment, a certain amount of catalyst was dispersed in deionized water. After stirring well for several hours, the sediment was removed by centrifugation. Then 30 mL solution was added into the reactor and H₂SO₄ was also used to adjust the pH value until pH=3. The catalyst usage is 8 mg unless otherwise stated. Afterwards, the well-dispersed solution was transferred into the reactor and 2 mL of H₂O₂ was added. Before light irradiation, the reactor was shielded to the light, ensuring that the adsorption equilibrium was established. During the photoreaction processes, the reaction system was under continuous magnetic stirring, while the temperatures of the reactor were controlled at 298±0.2 K by a recirculating cooling water system during irradiation. The light source for the photocatalysis was a 300 W Xe lamp with a standard AM 1.5 G filter, which could provide the one-sun irradiation from the top of the reactor. In order to investigate the strategy to enhance the photon transport and utilization efficiency, we sealed the reactor by wrapping the outer wall of the reactor with Al foil. The conversion rate was measured by adding 2 mL H₂O₂ into catalysts and plastic solution every 3 hours. The weight of PET has been obtained before light irradiation. After long time exposure, PET was dried and then was weighed to calculate the weight loss.

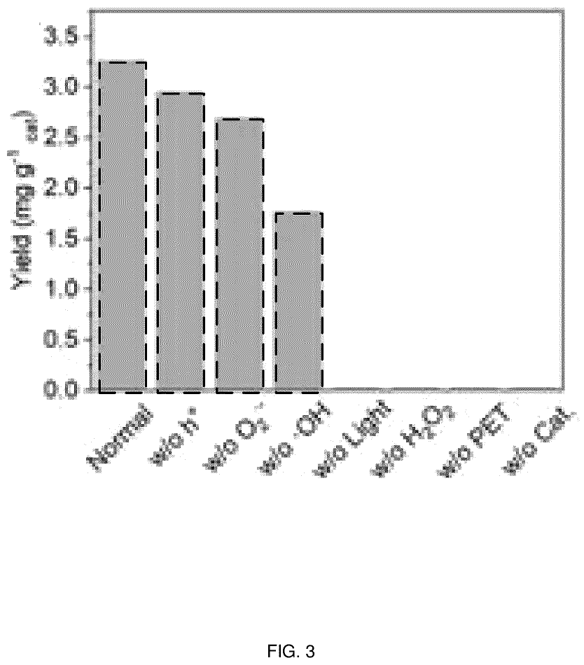

In particular, to better explain the mechanism of the Fe@C₃N₄ SAC/H₂O₂/Vis system, several factors were systematically studied which may affect the photocatalytic activity. The combination of H₂O₂, catalysts and light are used for the upcycling of PET. This process also involves the generation of some reactive oxygen species (ROS). To identify the primary ROS generated during photo-oxidation processes, different quenchers (Tert-butanol (TBA), p-benzoquinone (p-BQ), Ethylenediaminetetraacetic acid disodium salt (EDTA-2Na)) were applied for trapping and quenching ROS species, specifically *OH radicals, superoxide radicals (P²⁻) and hole (h⁺), respectively (FIG. 3). In particular, FIG. 3 depicts photocatalytic activation of Fe@C₃N₄ SAC for PET degradation in the presence of different scavengers. It was observed that TBA (w/o *OH), p-BQ (w/o O_{2′—) and EDTA-}2Na (w/o h⁺) all slowed down the photocatalytic upcycling processes of PET for the Fe@C₃N₄ SAC/H₂O₂/Vis system, with TBA (w/o *OH) having the most prominent inhibitory effect on the system. These results show that photocatalytic upcycling processes are facilitated by *OH radicals, and confirm that *OH radicals are the main functional ROS free radicals. Subsequently, these functional ROS free radicals would attack the plastics, degrading them into small molecule products (FIG. 2).

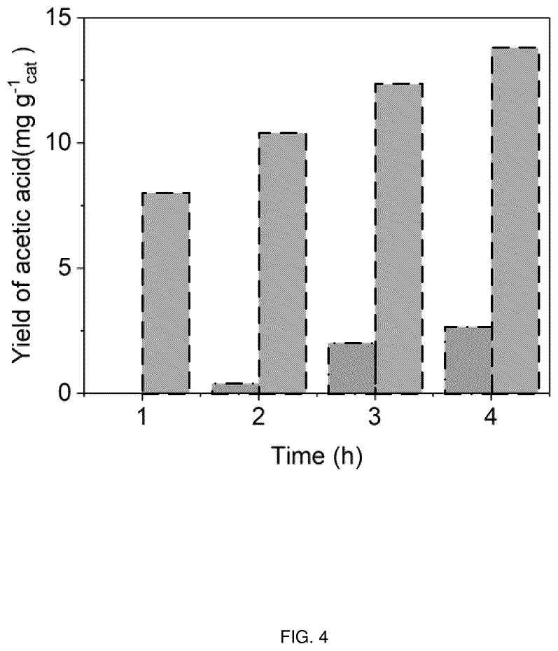

To verify whether CO₂ is an intermediate during the plastic upcycling photocatalytic reaction, the plastics were replaced with CO₂ gas while keeping all experimental conditions the same. When no plastic was added but pure CO₂ gas flowed into the reactor, acetic acid was still produced by the photocatalyst (FIG. 4). In FIG. 4, the Fe@C₃N₄ SAC/H₂O₂/Vis system is represented with a dashed outline, while C₃N₄/H₂O₂/Vis system is represented with a dot-dash outline. During the process, there were no plastics added. Rather, CO₂ was inserted into the reactor to check whether acetic acid would be generated. The results indicate that the plastic first undergoes a C—C bond cleavage process and oxidizes into CO₂ in the Fenton reaction, and then CO₂ is selectively converted to acetic acid by the CO₂ reduction reaction.

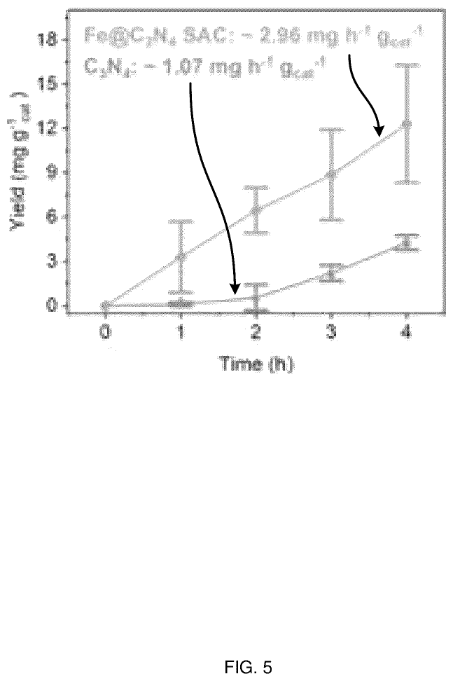

The experimental results demonstrate that Fe@C₃N₄ SAC shows a great improvement on the production of acetic acid compared with C₃N₄ due to the existence of Fe active sites (FIG. 5). In particular, FIG. 5 depicts the yield of acetic acid during the photocatalytic-induced degradation of pure PET with C₃N₄ or Fe@C₃N₄ SAC. The error bars in (b) represent the standard deviations of three independent measurements of the same sample.

In particular, the yield of the Fe@C₃N₄ SAC system is approximately 2.96 mg h⁻¹ g_{cat}⁻¹, where goat is the mass of the Fe@C₃N₄ SAC catalyst. By contrast, C₃N₄ has a low activity for degrading PET, which is about a third of the activity of Fe@C₃N₄ SAC. In addition, Fe@C₃N₄ SAC system enables efficient production of acetic acid under mild conditions without the aid of acid or base pretreatment or higher light intensity.

Table 1 outlines the relative plastic photocatalytic performance of certain photocatalysts

TABLE 1
Plastic photocatalytic performance of photocatalysts

| | | | | Pre-alkaline | | |
|---|---|---|---|---|---|---|
| | | | | heat | | Yield |
| | | Plastic | Light | hydrolyzed | | μmol mg_{cat}⁻¹ |
| | Catalysts | type | source(s) | treatment | Product | h⁻¹ |
| One step | Fe@C₃N₄ | PE | AM 1.5 G | No | acetic acid | 0.211483 |
| process | SAC | PET | AM 1.5 G | No | acetic acid | 0.089922068 |
| | | PP | AM 1.5 G | No | acetic acid | 0.088257 |
| | Nb₂O₅ | PE | AM 1.5 G | No | acetate | 0.000792646 |
| | | PP | AM 1.5 G | No | acetate | 0.000676081 |
| Two-step | Pt/g-C₃N₄ | PET | λ > 420 | Yes, 0.1M | terephthalate | 6.25 |
| process | | | nm | NaOH 60° C. | ethylene glycol | 5.9 |
| | | | | | formate | 0.31 |
| | d- | PET | 300 W | Yes, 2M KOH | glycolate | 2.777777778 |
| | NiPS₃/CdS | | Xenon | 60° C. 24 h | formate | 2.622222222 |
| | | | lamp | | acetate | 1.533333333 |
| | MoS₂/CdS | PET | AM 1.5 | Yes, 10M | formate | 0.72 |
| | | | | KOH 40° C. 48 h | | |
| | | | | Yes, 10 M | acetate | 0.114 |
| | | | | KOH 40° C. 48 h | | |
| | CPDs-CN | PET | AM 1.5 G | Yes, 5M KOH | acetic acid | 0.144270833 |
| | | | | 120° C. 24 h | glycolic acid | 0.099739583 |
| | | | | | formic acid | 0.036197917 |
| | | | | | ethanol | 0.033333333 |
| | | | | | glycolaldehyde | 0.028645833 |
| | | | | | acetaldehyde | 0.011197917 |
| | P25\|Pt | PE | AM 1.5 G | Yes, 180° C. for | ethane | 0.0563 |
| | | | | 4 h with 6 wt. % | | |
| | | | | HNO₃ | | |
| | CNₓ\|Ni₂P | PET | AM 1.5 G | Yes, 1M KOH | glyoxal | 0.02421875 |
| | | | | 40° C. 24 h | acetate | 0.000494792 |
| | | | | | formate | 0.000494792 |

In contrast with the two-step processes, the presently described Fe@C₃N₄ SAC does not require a pre-alkaline hydrolyzed treatment, costing additional energy and lowering the energy efficiency of the process. Further, the strongly alkaline solution may cause adverse environmental effects. Additionally, λ>420 nm results in a light intensity of about 450 mW cm⁻², while a 300 W Xenon lamp is about 3,000 suns, or about 300,000 mW cm⁻² light intensity. In contrast, AM 1.5 G corresponds to a light intensity of about 100 mW cm⁻², thereby relatively reducing the energy input required for the photocatalysis.

Further, as can be seen, the presently described Fe@C₃N₄ SAC provides at least two orders of magnitude of improvement in yield over the comparable one-step process.

The conversion rate of PET was tested over 54 hours and showed a conversion rate of 0.1 mg h⁻¹ mg_{cat}⁻¹ under the Fe@C₃N₄ SAC/H₂O₂/Vis system as described above.

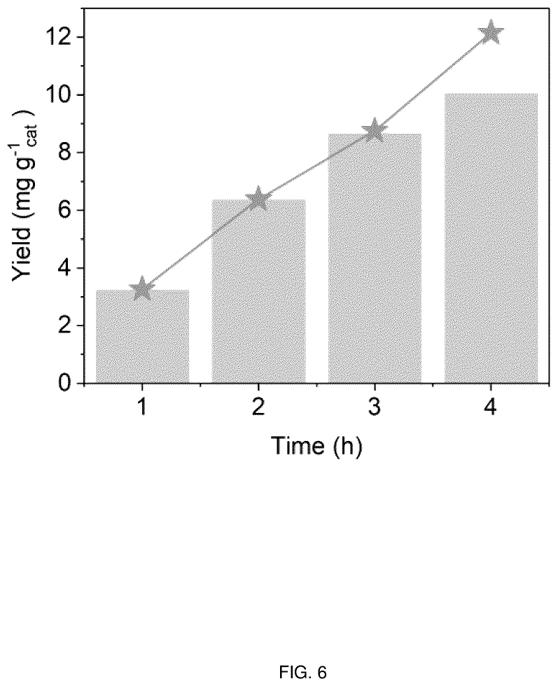

To check whether the H₂O₂ amount is enough to drive the reactions (FIG. 6), all chemicals were used in the same amount in the first hour in the Fe@C₃N₄ SAC/H₂O₂/Vis system. There was no additional H₂O₂ supplied to the system after the first hour. Evidence for excess H₂O₂ in the reaction was revealed by continued production of acetic acid during the following three hours, as depicted in FIG. 6.

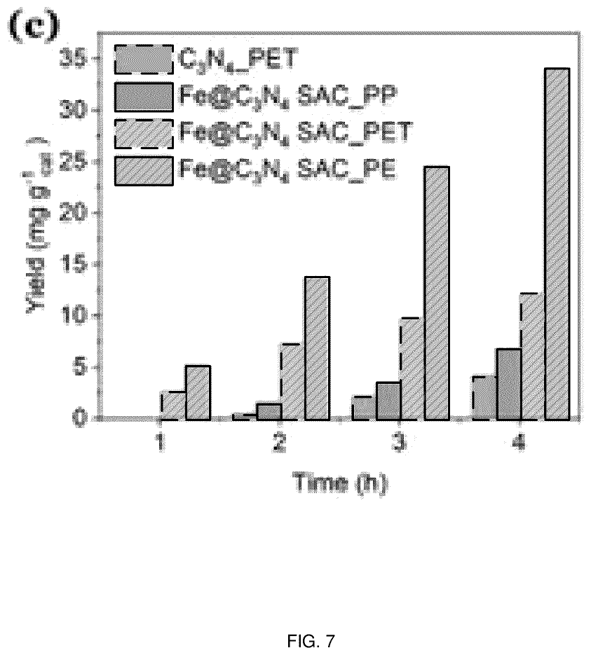

Further, the presently described system and method demonstrates promising plastic upcycling efficiency and is effective for diverse plastic waste (i.e., PP, PE and PET) (FIG. 7). In particular, FIG. 7 depicts the results of plastic upcycling of PET, PE, and PP using an uncovered reactor with Fe@C₃N₄ SAC or C₃N₄.

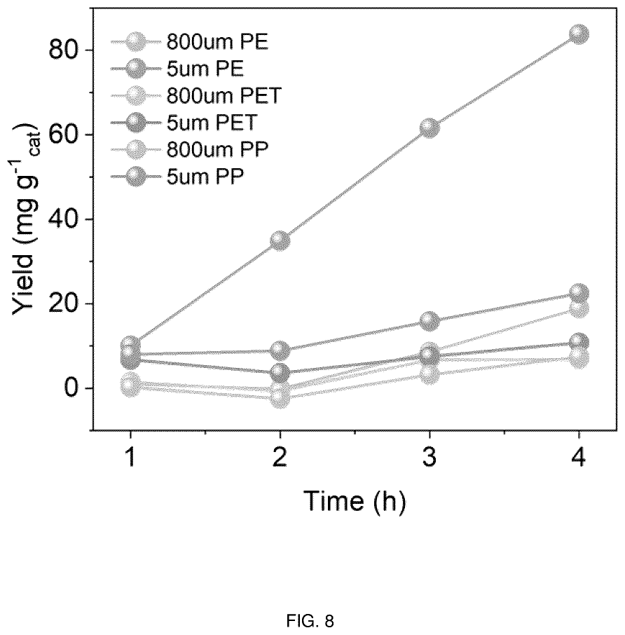

As can be seen, a higher yield of acetic acid was observed when using PE. One possible reason is that the smaller the particle size of the plastic, the greater the specific surface area in contact with the catalyst solution, and the more acetic acid is produced (FIG. 8). In addition, compared to PET at the same size, PE has a simpler chemical structure, making it more susceptible to free radical attack. In particular, FIG. 8 depicts the effect of the particle size of plastics with the use of the Fe@C₃N₄ SAC photocatalysts. In the experimental setup of FIG. 8, the usage of Fe@C₃N₄ SAC is 3.5 mg.

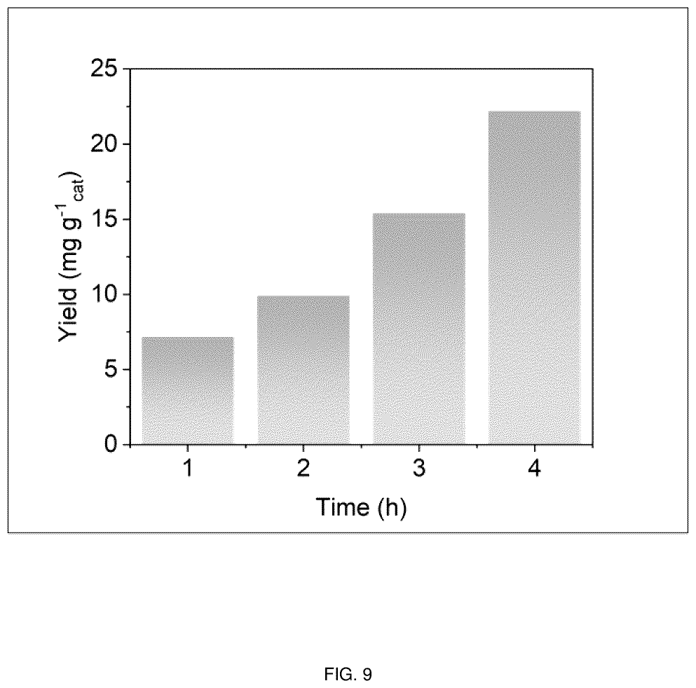

Furthermore, we also conducted experiments with mixed plastics, and the results, as shown in FIG. 9, indicate that our system is capable of efficiently converting mixtures of plastic waste into acetic acid. In particular, FIG. 9 depicts the yield of acetic acid from PP, PET and PE (the total usage of mixed plastics is 1 g) under the Fe@C₃N₄ SAC/H₂O₂/Vis System.

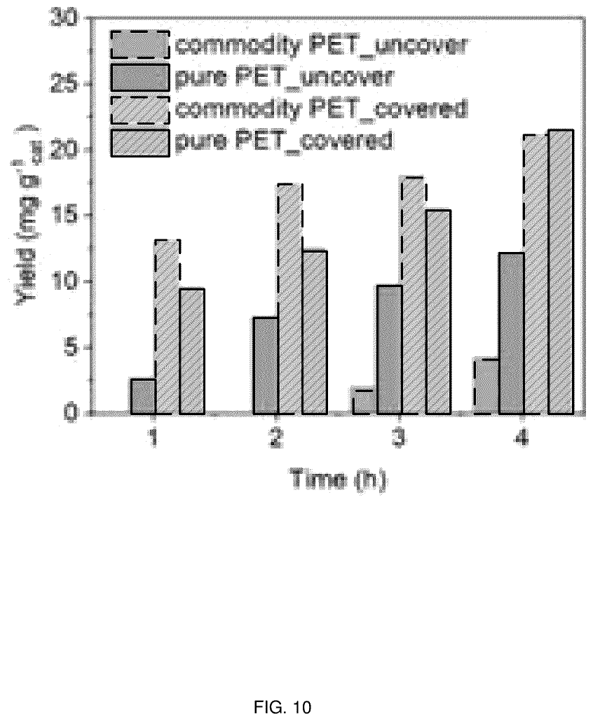

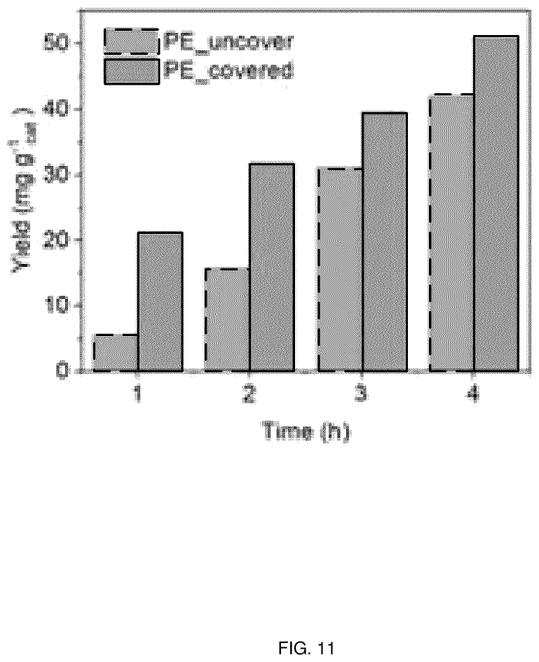

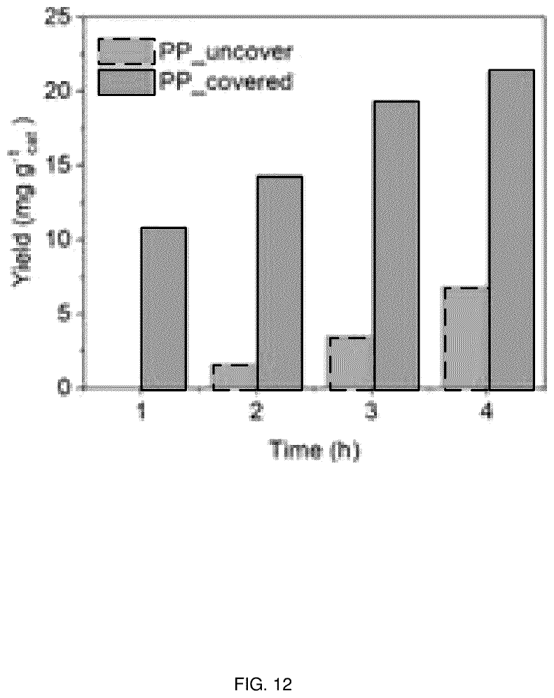

To investigate the effect of additives in the commercial plastics, and the effect of light trapping in the reactor, we systematically studied these two effects on the product yield of acetic acid from photocatalytic upcycling processes. FIG. 10 depicts the effect of light trapping in the reactor for commodity PET with 30% glass fibers and pure PET upcycling to acetic acid using the Fe@C₃N₄ SAC photocatalyst. FIG. 11 depicts the effect of light trapping in the reactor for PE upcycling to acetic acid using the Fe@C₃N₄ SAC photocatalyst. FIG. 12 depicts the effect of light trapping in the reactor for PP upcycling to acetic acid using the Fe@C₃N₄ SAC photocatalyst. Comparing the catalytic reaction of commercial PET vs. pure PET under the same conditions, the additives in commercial plastic lowered the yield of acetic acid. Processes to remove the additives in the commercial plastics can improve the yield of acetic acid. The yield of acetic acid was significantly enhanced by light trapping via wrapping the reactor with Al foil, up to five times that of the unwrapped reactor (in the case of commercial PET). This is because photon would be trapped within the reactor and transport by internal. This reveals the importance of light trapping and photon transport in the reactor, which can increase the efficiency of light utilization by the reactor.

Accordingly, a sustainable and efficient cascade photocatalysis method for upcycle plastics to value-added acetic acid using Fe single atom catalysts (Fe@C₃N₄ SAC) at room temperature and ambient conditions without any CO₂ emission is demonstrated. That is, the Fe@C₃N₄ SAC is synthesized and acts as a bifunctional cascade photocatalyst for both Fenton-like and CO₂ reduction reactions, as inspired by microbial, especially Phanerochaete chrysosporium, degradation processes of polymer lignin to small molecules without the releasing of CO₂. To better understand the Fe@C₃N₄ SAC, the Fe@C₃N₄ SAC was studied and characterized both ex-situ and in situ during the cascade photocatalysis.

According to one example, the Fe@C₃N₄ SAC catalysts may be prepared according to the following procedure. A homogeneous solution of 2 g melamine and 20 mg FeCl₃·6H₂O was dispersed separately in ultrapure water and then mixed together. After continuous magnetic stirring at 100° C., the water in the resulting mixture was completely evaporated. Afterwards, the obtained sample was calcined in a tube furnace at 550° C. for 4 h under an argon atmosphere. The as-prepared sample was then collected and labeled as Fe@C₃N₄ SAC. The mass ratio of iron (0.5 wt. %) in Fe@C₃N₄ SAC was determined by inductively coupled plasma mass spectrometry (ICP-MS).

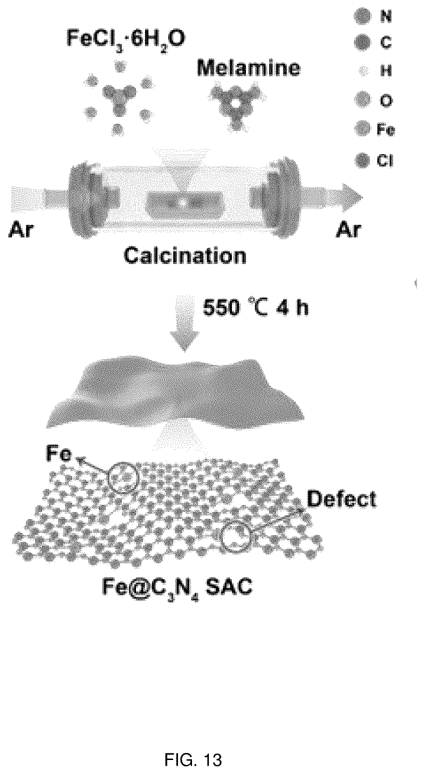

For example, referring to FIG. 13, a schematic diagram of the synthesis procedure of graphitic carbon nitride (C₃N₄) and Fe@C₃N₄ SAC are illustrated. As described above, melamine was thoroughly mixed with an amount of iron salt and calcined in a tube furnace to finally obtain the photocatalyst.

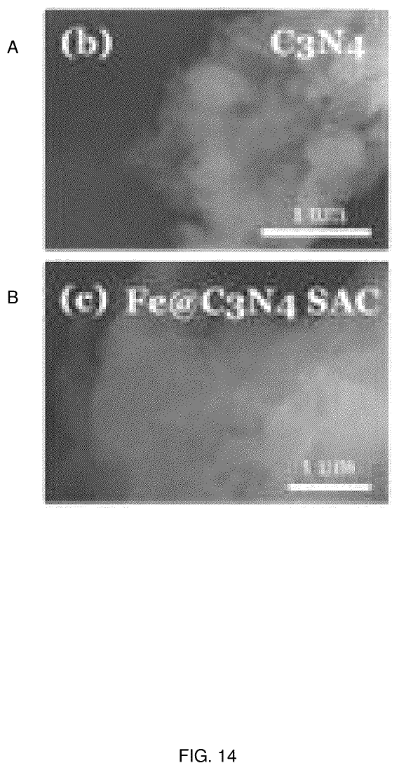

FIG. 14A depicts a scanning electron microscope (SEM) image showing the morphology of the C₃N₄ nanosheet. The crumpled nanosheets are highly curved and able to stack on top of each other like petals. The loose morphology allows the materials to have pores of a few microns in diameter, which facilitates adsorption and contact between the active molecules and the organic matter. Fe@C₃N₄ SAC shows a similar structure (FIG. 14B), but the Fe single atoms cannot be observed in SEM due to inadequate spatial resolution. The maintenance of morphology reveals that Fe incorporation into C₃N₄ does not change the original lamellar structure.

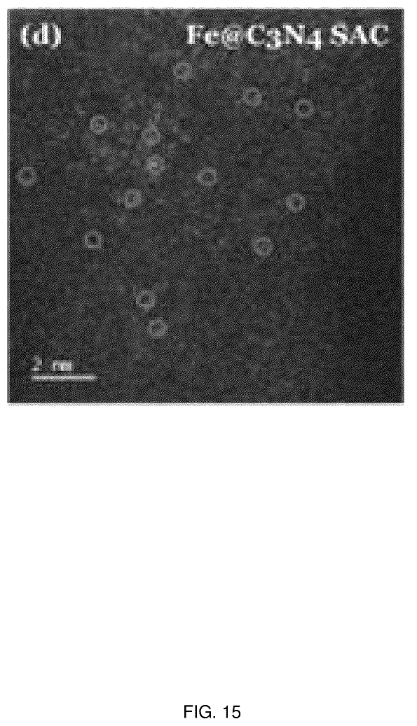

To reveal the distribution of Fe single atoms in the catalyst, probe aberration-corrected high-angle annular dark field scanning transmission electron microscopy (AC-HAADF-STEM) was carried out. The resulting image is depicted in FIG. 15. According to the z-contrast, the bright spots (examples labelled with circles in FIG. 15) represent Fe single atoms which are uniformly dispersed on the C₃N₄ support framework. This indicates that Fe single atoms were successfully introduced into the C₃N₄ structure.

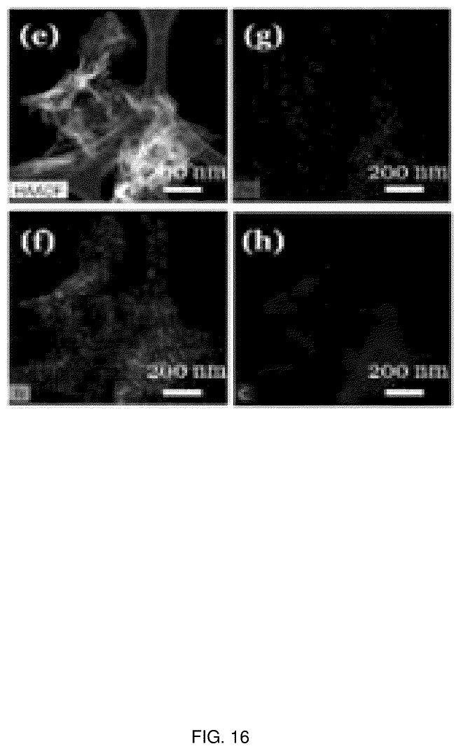

FIGS. 16A-D depict scanning transmission electron microscopy energy dispersive X-ray spectroscopy (STEM-EDX) elemental mapping images of Fe@C₃N₄ SAC. In particular, the energy dispersive X-ray spectroscopy (EDX) elemental mapping results further confirm homogenous distribution of Fe single atoms on the C₃N₄ support framework. Inductively coupled plasma mass spectrometry (ICP-MS) analysis indicates that the Fe content in Fe@C₃N₄ SAC was 0.5 wt. %. This result explains why the signal of Fe single atoms is relatively weak in EDX mapping. Similarly, the post-irradiation samples were subjected to ICP-MS analysis. The result shows an iron mass fraction of 0.5%, indicating there is no leaching of iron from the as-synthesized catalyst.

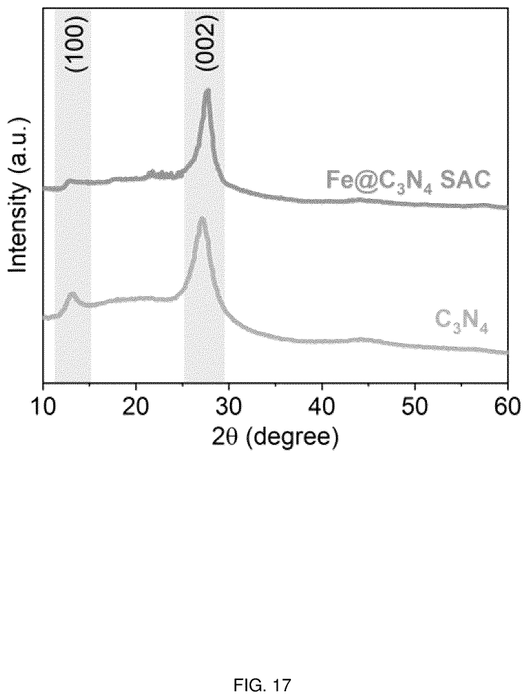

X-ray powder diffraction (XRD) analysis of C₃N₄ and Fe@C₃N₄ SAC was carried out (FIG. 17). Two diffraction peaks appeared at 13.3° and 27.4° in C₃N₄, which are referred to as the standard card (JCPDS 87-1526). As shown, the sharp peaks at 27.4° are formed by the rr-rr interlayer stacking reflection with an interplanar separation of 0.34 nm, indexed as the (002) diffraction peak. The broad peaks located at 13.3°, indexed as (100), are generated due to the in-plane structural packing motif, representing an interplanar distance of 0.68 nm. Compared to C₃N₄, Fe@C₃N₄ SAC shows a decreased intensity of diffraction peaks of the (100) and (002) planes. This is due to the formation of Fe—Nₓ coordination bonds between iron and nitrogen atoms during calcination, which ruins the repetitive arrangement of the basic units in C₃N₄. The results indicate that Fe species are sufficiently embedded in the C₃N₄ skeleton.

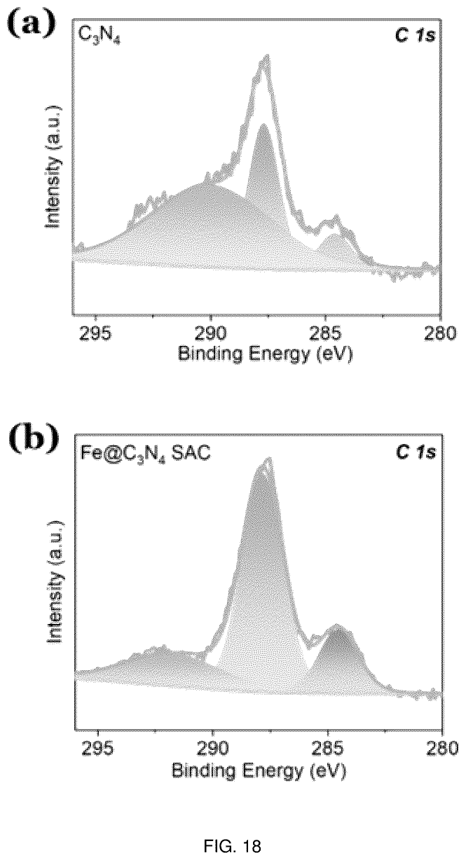

The chemical valence states and elemental compositions were studied by X-ray photoelectron spectroscopy (XPS). High resolution of C is XPS spectrum is depicted (FIG. 18). The peak is deconvoluted into three peaks of C—C, C—N—C and C—O bonds, which are located at 285.1 eV, 288.2 eV and 289.2 eV, respectively. The C 1s spectrum of C₃N₄ and Fe@C₃N₄ SAC are similar. However, the peak area for Fe@C₃N₄ SAC corresponding to the (N)₂—C═N groups at 288.2 eV is larger because Fe—Nₓ bonds formed and affected the chemical environment of the adjacent C atoms in the original structure. Given that it is easy for carbon peaks to be contaminated by the background environment, the nitrogen spectra are key when considering the bonding structure.

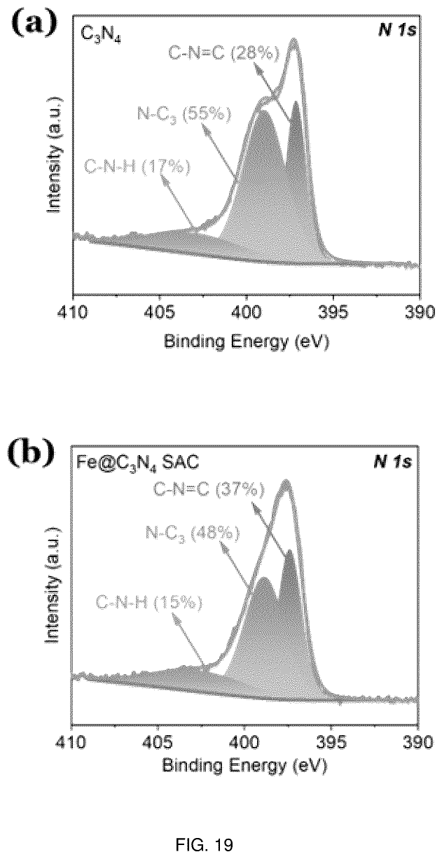

The characteristic N 1s peaks could be clearly observed in FIG. 19 which depicts high-resolution N 1s XPS spectra of (a) C₃N₄ and (b) Fe@C₃N₄ SAC. Three typical N 1s core levels are located at 398.60 eV, 399.81 eV and 401.11 eV. These peaks correspond to sp² C—N═C, sp³ N—C₃ and C—N—H (—NH₂ or ═NH) and the fractional abundances of these bonds are 0.28, 0.55 and 0.17, respectively. It is noted that N—Fe bonds are also located at 398.8±0.5 eV, and are difficult to distinguish from C—N═C bonds. A similar characteristic peak can also be observed in the N is high-resolution spectrum of Fe@C₃N₄ SAC, which further indicates the successful embedding of Fe species into the C₃N₄ lattice. From Fe 2p spectra in Fe@C₃N₄ SAC, two main broad peaks at about 710 and 724 eV are observed, which can be attributed to typical Fe 2p_{3/2} and Fe 2p_{1/2} signals.

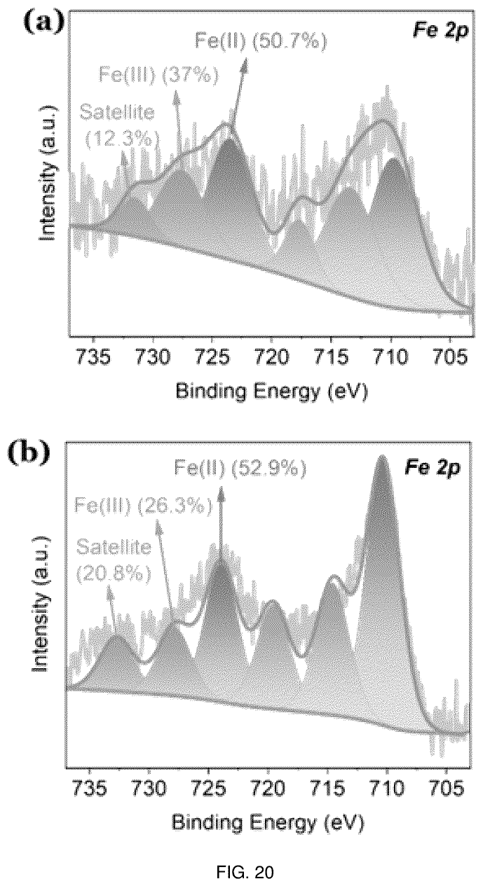

These two main peaks could be separated into sub-peaks, as seen FIG. 20, which depicts high-resolution Fe 2p XPS spectra of (a) Fe@C₃N₄ SAC before irradiation and (b) Fe@C₃N₄ SAC after irradiation. The absence of a metallic Fe peak indicates that Fe atoms successfully connect to C₃N₄, which is consistent with the HAADF-STEM imaging (FIG. 15). The Fe 2p spectra of Fe@C₃N₄ SAC after light irradiation, as shown in the FIG. 20, reveals a noticeable increase in the proportion of satellite peaks. This observation may be attributed to changes in the coordination environment and alterations in the electronic structure of the single-atom iron sites. During the irradiation process, photogenerated electrons reduce Fe(III) to Fe(II). However, the Fe(II) species are rapidly consumed in subsequent Fenton reactions. As a result, the overall concentration of Fe(II) does not exhibit a significant change, despite the dynamic redox cycle facilitated by light exposure.

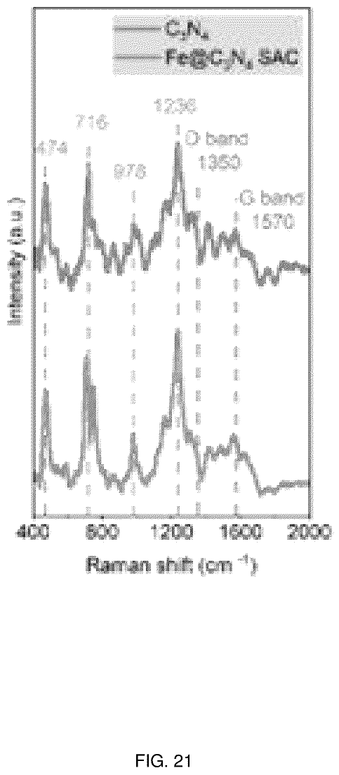

To investigate the surface defects of the synthesized catalysts, Raman spectroscopy was carried out. FIG. 21 depicts the Raman spectroscopy of C₃N₄ and Fe@C₃N₄ SAC. The Raman spectra were recorded with exciting laser at 785 nm. Synchrotron X-ray spectroscopy characterization of Fe@C₃N₄ photocatalyst from Advanced Photon Source. The peaks located at 1350 and 1570 cm⁻¹, respectively, are attributed to the D peak and the G peak. It is noted that the I_{D}: I_{G} value of Fe@C₃N₄ SAC is larger than that of C₃N₄, indicating an increased defective degree. This may be due to the breaking of N═C—N bonds by introducing Fe single atoms on C₃N₄. In addition, there are other distinct peaks. The vibrational peaks at 474 and 716 cm⁻¹ are associated with characteristic vibrations of s-triazine ring and C═N, respectively. Other dominant peaks at 978 and 1236 cm⁻¹ are separately derived from breathing modes of symmetric N in heptazine units and s-triazine.

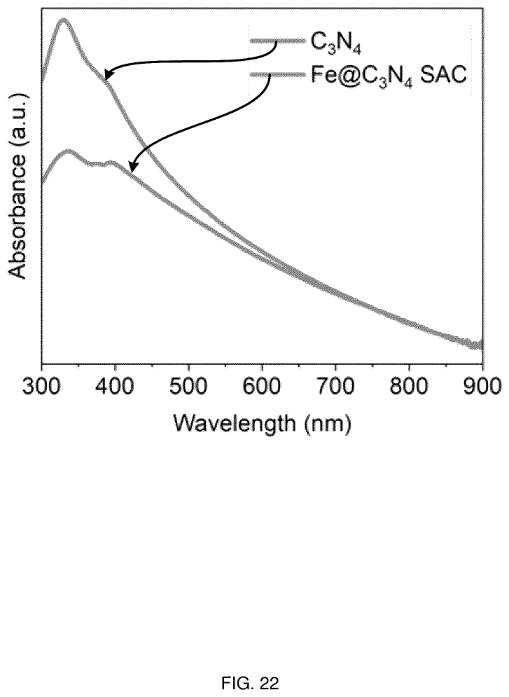

UV-Vis absorption spectroscopy was carried out to analyze the optical properties of C₃N₄ and Fe@C₃N₄ SAC (FIG. 22). Both C₃N₄ and Fe@C₃N₄ SAC have the same energy absorption edge in the ultraviolet and visible light region. As an excellent light absorption material, C₃N₄ has an intrinsic absorption edge at about 460 nm (˜2.7 eV). The introduction of Fe single atoms does not change the absorption edge of C₃N₄.

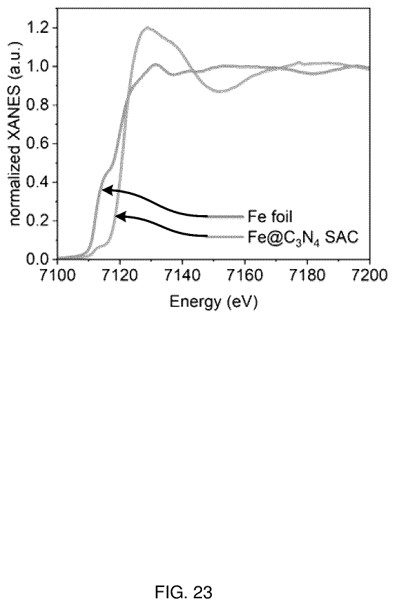

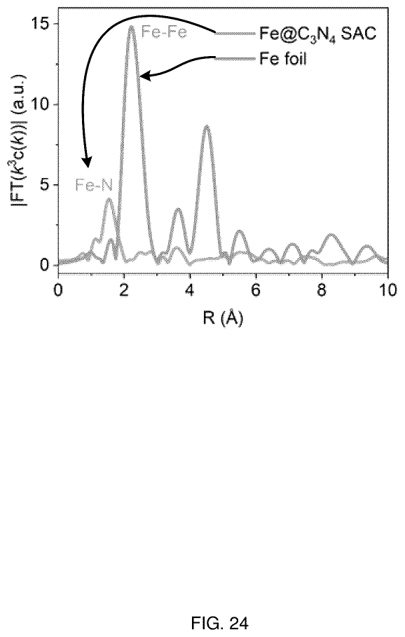

To better understand electronic structures and coordination environment of the Fe atoms, the hard X-ray absorption spectroscopies were measured at Advanced Photon Source, Argonne National Laboratory. The Fe K-edge X-ray absorption near-edge structure (XANES) spectra of Fe@C₃N₄ SAC is presented with Fe foil as a reference (FIG. 23). FIG. 23 depicts the Fe K-edge X-ray absorption near-edge structure (XANES) spectra of Fe@C₃N₄ SAC and Fe foil. As can be seen, the absorption edge is higher than that of Fe foil, demonstrating that the valence of Fe single atoms in Fe@C₃N₄ SAC is higher than metallic Fe. Moreover, a pre-edge peak around 7114 eV can be attributed to the Fe—N₄ structure, consistent with previous reports. The k³-weighted Fourier transformation of Fe K-edge from extended X-ray absorption fine structure (EXAFS) spectra for Fe@C₃N₄ SAC and Fe foil are shown to further verify the accurate coordination information (FIG. 24). Specifically, FIG. 24 shows the Fourier-transformed (FT) curves at R space for Fe@C₃N₄ SAC and Fe foil. The Fe@C₃N₄ SAC shows a radial distance of about 1.6 Å, which is very close to Fe—N peak of FePc. The Fe in Fe@C₃N₄ SAC are single atoms, which is consistent with the absence of a peak at around 2.2 Å that would be expected for Fe—Fe bonds.

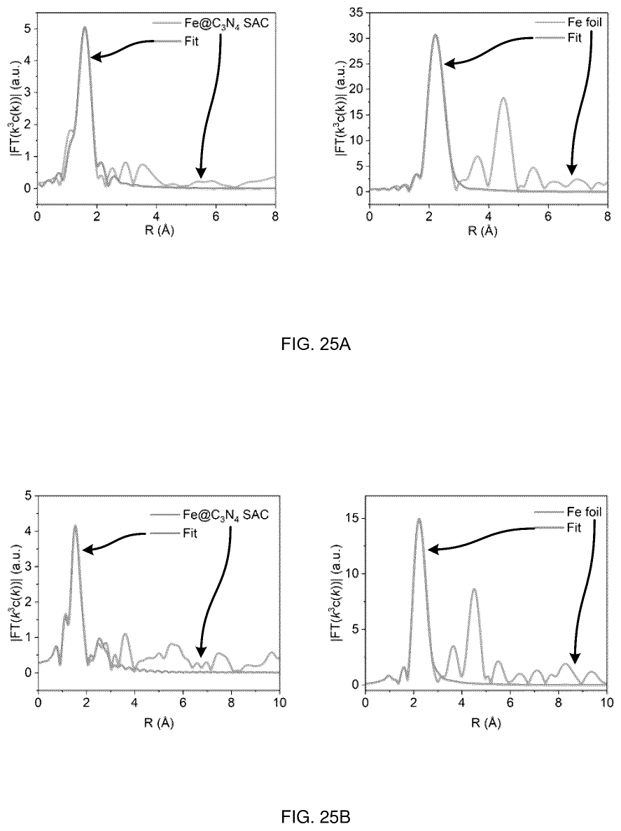

The corresponding fitting results are presented in FIGS. 25A and 25B, which depict (A) synchrotron X-ray spectroscopy characterization of the Fe@C₃N₄ SAC photocatalyst and the corresponding EXAFS R space fitting result of the first coordination shell for (a) Fe@C₃N₄ SAC and (b) Fe foil; and (B) synchrotron X-ray spectroscopy characterization of the Fe@C₃N₄ SAC photocatalyst from SXRMB and the corresponding EXAFS R space fitting result of the first coordination shell for (a) Fe@C₃N₄ SAC and (b) Fe foil.

Table 2 presents the fitting parameters of ex situ synchrotron X-ray absorption spectroscopy characterization from Advanced Photon Source at Argonne National Laboratory, including coordination number (CN), the inner potential correction (AE), Debye-Waller factors (a²) and atomic distance (R-factor).

TABLE 2

| | bond | length | CN | ΔE (eV) | σ² (10⁻³ Å²) | R-factor (Å) |
|---|---|---|---|---|---|---|
| Fe@C3N4 SAC | Fe—N | 2.07 (+−0.06) | 4.0 (+−0.4) | 4.8 (+−0.4) | 4.9 (+−0.5) | 0.008 |
| Fe Foil | Fe—Fe | 2.56 (+−0.04) | 12* | 4.8 (+−0.6) | 3.8 (+−0.6) | 0.009 |

Table 3 presents the fitting parameters of synchrotron X-ray spectroscopy characterization from SXRMB at Canadian Light Source, including coordination number (CN), the inner potential correction (AE), Debye-Waller factors (σ²) and atomic distance (R-factor).

TABLE 3

| | bond | length | CN | ΔE (eV) | σ² (10⁻³ Å²) | R-factor (Å) |
|---|---|---|---|---|---|---|
| Fe@C3N4 SAC | Fe—N | 2.07 (+−0.08) | 3.8 (+−0.5) | 4.8 (+−0.2) | 8.7 (+−0.2) | 0.005 |
| Fe Foil | Fe—Fe | 2.55 (+−0.08) | 12* | 6.6 (+−0.5) | 4.8 (+−0.7) | 0.008 |

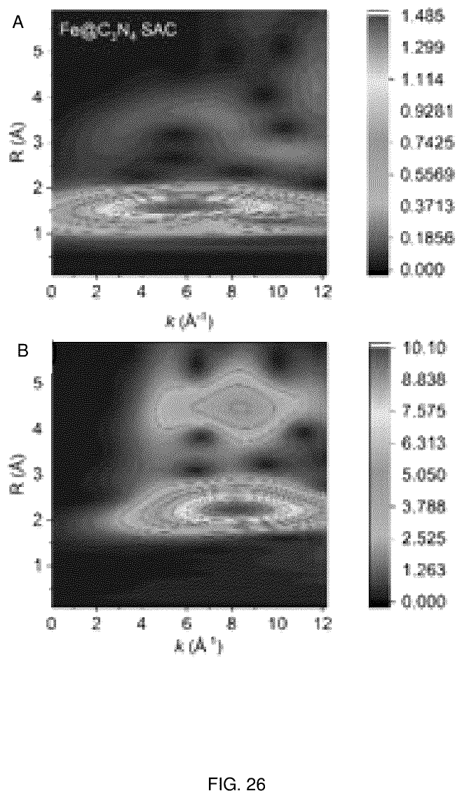

FIGS. 26A and 26B depict the Wavelet transform (WT) of EXAFS at Fe K-edge for Fe@C₃N₄ SAC and Fe foil as a reference. Wavelet transform (WT) analysis of Fe@C₃N₄ SAC shows one maximum intensity at 4 Å⁻¹, matching well with the Fe—N bond in the reference FePc (FIG. 26A). Compared with the WT plots of Fe foil (FIG. 26B), there is no metallic Fe—Fe scattering signal (˜8 Å⁻¹) detected. Combined with the absence diffraction peaks associated with the crystalline iron species (FIG. 17), it is further confirmed that iron are present as single atoms that connect with N atoms and are fixed in the C₃N₄ framework, which is consistent with the AC-HAADF-STEM measurement (FIG. 15).

The Fe@C₃N₄ photocatalyst was further characterized in situ during the cascade photocatalysis.

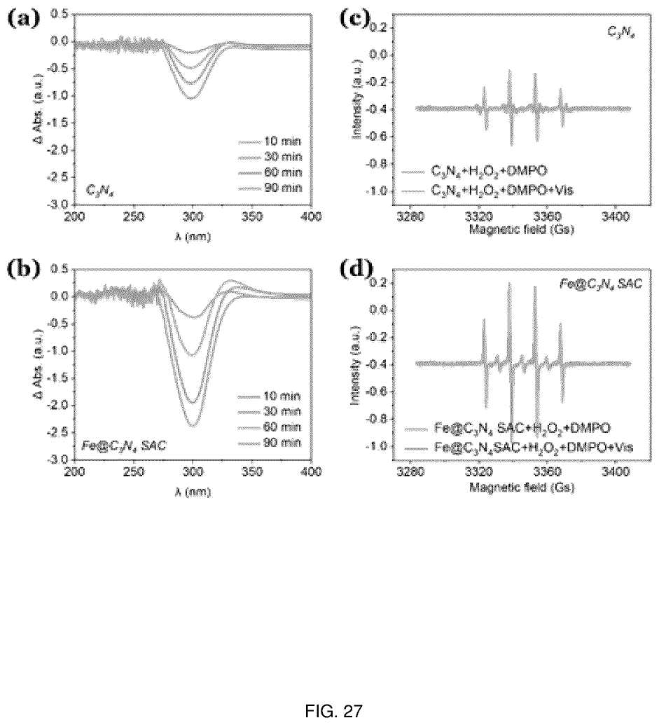

FIG. 27 depicts operando UV-Vis spectra of (a) C₃N₄ and (b) Fe@C₃N₄ SAC during photocatalytic upcycling processes and operando electron paramagnetic resonance spectroscopy (EPR) spectra of the DMPO-*OH over (c) C₃N₄ and (d) Fe@C₃N₄ SAC solutions with/without visible light irradiation.

To further identify the *OH radicals formed during the PET photocatalytic upcycling processes, ultraviolet-visible (UV-Vis) absorption spectra were obtained (FIGS. 27A-B). It is known that *OH radicals can be directly detected by UV-Vis through adding salicylic acid (SA). According to the results, the Fe@C₃N₄ SAC system has higher *OH generation ability compared to the C₃N₄ system under the same conditions (FIGS. 27A-B). To cross verify, electron paramagnetic resonance (EPR) spectra were employed (FIGS. 27C-D). Apparently, characteristic peaks of 1:2:2:1 ratio existed in all systems (FIGS. 27C-D), which could be assigned to DMPO-*OH. This observation implies that H₂O₂ decomposed and *OH radicals formed during the photocatalytic processes. Although the peaks are at the same positions, the signals for Fe@C₃N₄ SAC are more obvious and stronger than the peaks for C₃N₄, which suggests higher *OH generation ability by Fe@C₃N₄ SAC in the photocatalytic upcycling processes (FIGS. 27C-D). Therefore, all analyses above revealed that the efficiency of photocatalytic plastic upcycling is enhanced by the introduction of Fe single atoms as active sites.

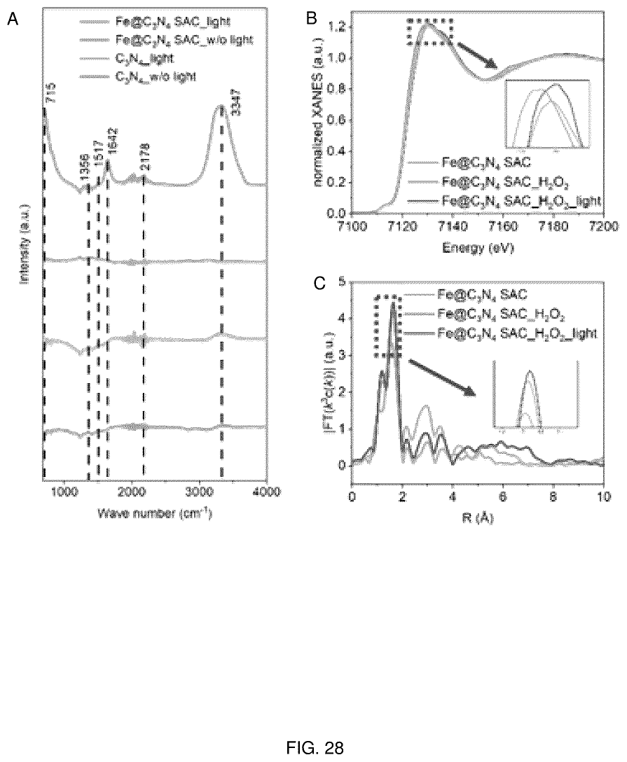

FIG. 28A depicts operando Fourier transform infrared spectroscopy (FTIR) spectra of C₃N₄ and Fe@C₃N₄ SAC and operando synchrotron hard X-ray absorption spectroscopy of Fe@C₃N₄ SAC during the cascade photocatalysis from Hard X-ray MicroAnalysis (HXMA). FIG. 28B depicts the Fe K-edge XANES and FIG. 28C depicts the corresponding EXAFS R space results.

To detect the intermediate species and products during the photocatalytic plastic upcycling processes, operando Fourier transform infrared spectroscopy (FTIR) was performed. The vibrational peaks for the Fe@C₃N₄ SAC system are more pronounced than C₃N₄ (FIG. 28A). The broad band of 3347 cm⁻¹ can be explained by CO₃*⁻·nH₂O. The peak at 2178 cm⁻¹ originates from C—O stretching. This is due to the absorption of CO intermediates on the photocatalysts, which is also confirmed by the DFT calculations as described in further detail below. The newly emerged band at 1642 cm⁻¹ derives from C═C stretching. The absorption bands situated at 1517 and 1356 cm⁻¹ are ascribed to COO⁻ stretching. After photocatalysts are exposed to one-sun light radiation and reacted with the plastic, the intensity of these peaks increase, indicating that *COOH acts as an intermediate in the production of acetic acid. This is also confirmed by DFT calculations as described in further detail below. Additionally, the peak at 715 cm⁻¹ is contributed by the PET structure.

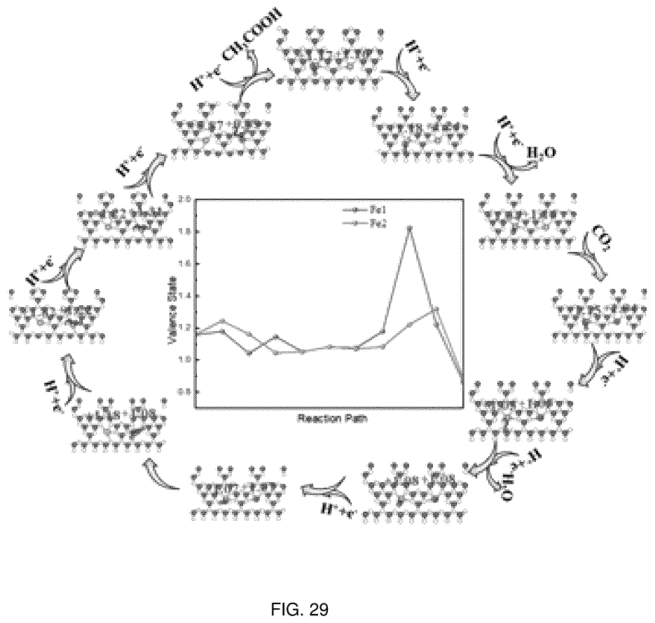

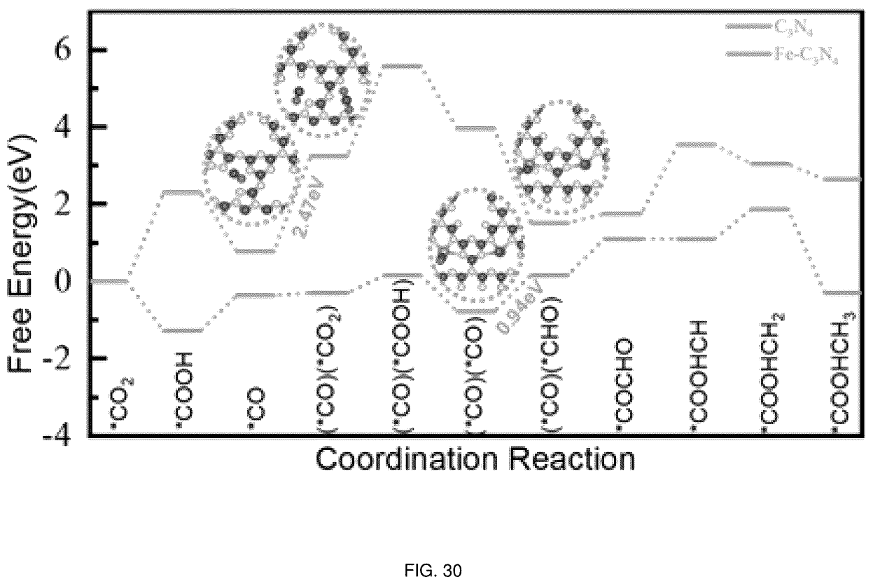

To further reveal the valence state and local structure of Fe, the operando synchrotron X-ray absorption spectra were analyzed. FIG. 28B shows in situ XANES Fe K-edge of Fe@C₃N₄ SAC under reaction conditions. FIG. 29 shows CO₂ reduction reaction pathway for Fe@C₃N₄ SAC and C₃N₄ with their reaction pathway. Apparently, the changes of absorption edge are not obvious, suggesting that the Fe valence state is stable before and after light irradiation, which is also confirmed by DFT calculations (in the inset of FIG. 29). One can observe that the average valence of Fe is +1.1, with a relatively narrow distribution from +0.9 to +1.8. Though a high Fe valence is observed at the *COOHCH intermediate as shown in FIG. 29, the intermediates of (*CO)(*CHO) and *COCHO are more stable than the *COOHCH intermediate (FIG. 30). Specifically FIG. 30 shows the calculated Gibbs free energy diagram of the CO₂ reduction reaction pathway for Fe@C₃N₄ SAC and C₃N₄.

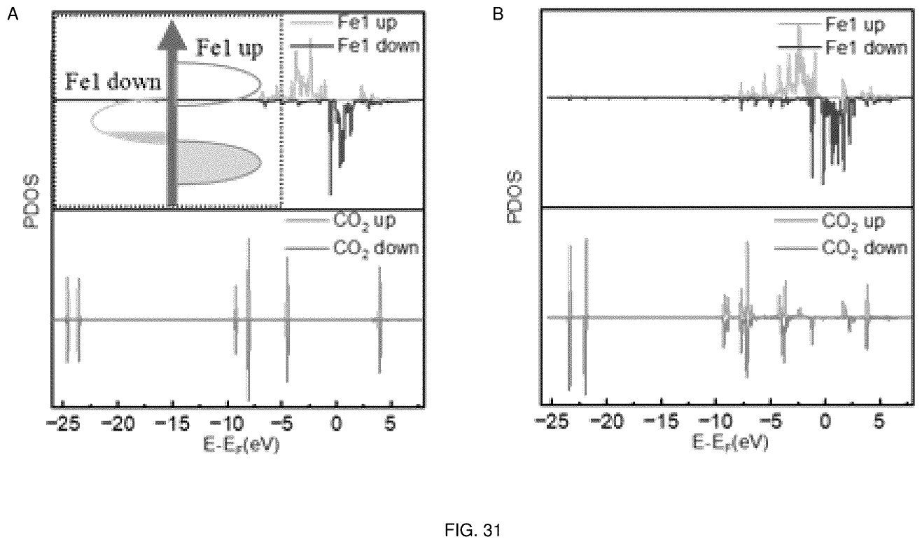

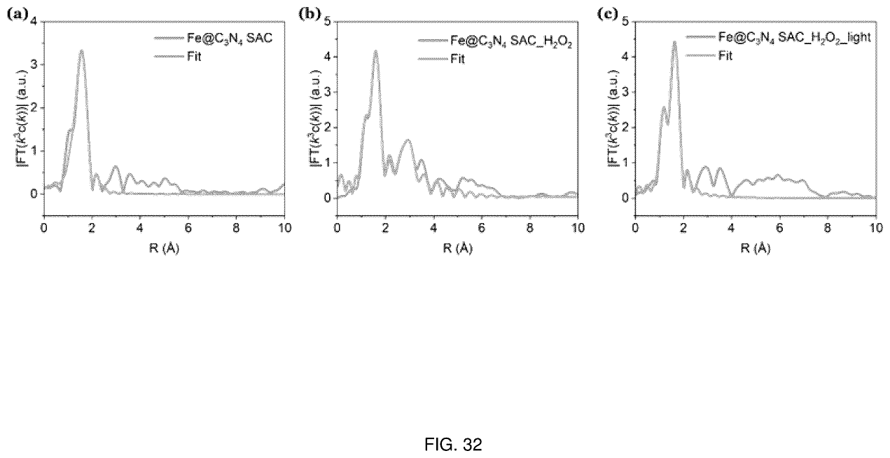

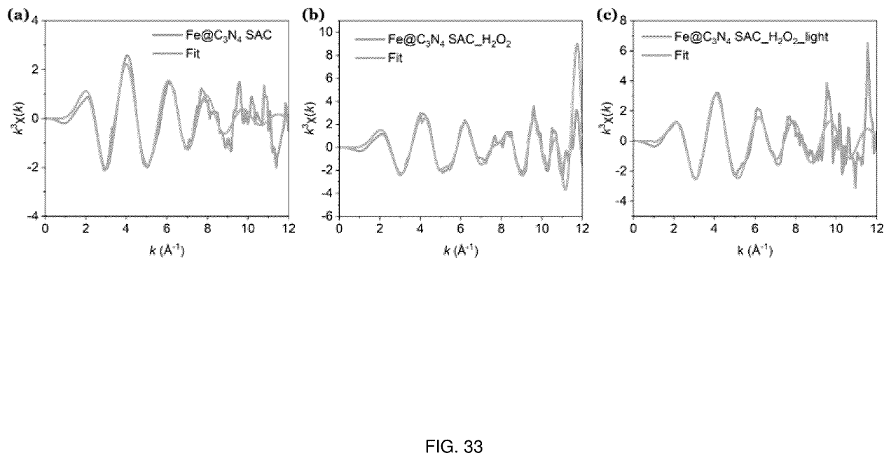

Thus, a metastable *COOHCH intermediate with high Fe valence shows a short duration. As shown by the magnified white line peak (the inset of FIG. 28B), the peak intensity increases under light irradiation, indicating an occurrence of electron transfer. In addition, the local coordination environment of Fe was studied by comparing the EXAFS of Fe K-edge spectra (FIG. 31). Specifically, FIGS. 31A and 31B shows the projected density of states (PDOS) of Fe and CO₂ before (FIG. 31A) and after (FIG. 31B) the adsorption of CO₂ on the Fe1 site of Fe@C₃N₄ SAC. There is a slight increase in the intensity of the Fe—N peak, which elucidates the alternation of the local Fe atomic arrangement. The corresponding fitting curves are shown in FIGS. 32 and 33 and the fitting parameters are provided in Table S4. Specifically, FIG. 32 depicts in situ synchrotron X-ray absorption spectroscopy of Fe@C₃N₄ SAC during the cascade photocatalysis from Hard X-ray MicroAnalysis (HXMA). The corresponding EXAFS R space fitting result of the first coordination shell for (a) pure Fe@C₃N₄ SAC, (b) adding H₂O₂ into Fe@C₃N₄ SAC in the dark and (c) adding H₂O₂ into Fe@C₃N₄ SAC under the light irradiation. FIG. 33 depicts in situ synchrotron X-ray absorption spectroscopy of Fe@C₃N₄ SAC during the cascade photocatalysis from Hard X-ray MicroAnalysis (HXMA). The corresponding EXAFS k-weighted k-space fitting result for (a) pure Fe@C₃N₄ SAC, (b) adding H₂O₂ into Fe@C₃N₄ SAC in the dark and (c) adding H₂O₂ into Fe@C₃N₄ SAC under the light irradiation.

Table 4 presents the fitting parameters of in situsynchrotron hard X-ray absorption spectroscopy, including coordination number (CN), the inner potential correction (AE), Debye-Waller factors (a²) and atomic distance (R-factor).

TABLE 4

| | bond | length | CN | ΔE (eV) | σ² (10⁻³ Å²) | R-factor (Å) |
|---|---|---|---|---|---|---|
| Fe@C3N4 SAC | Fe—N | 2.06 (+−0.05) | 4.0 (+−0.2) | 2.8 (+−0.2) | 3.9 (+−0.8) | 0.010 |
| Fe@C3N4 SAC_{—} | Fe—N | 2.07 (+−0.06) | 5.3 (+−0.7) | 1.5 (+−0.6) | 6.8 (+−0.9) | 0.003 |
| H2O2 | | | | | | |
| Fe@C3N4 SAC_{—} | Fe—N | 2.10 (+−0.04) | 3.8 (+−0.3) | 5.2 (+−1.4) | 8.4 (+−0.2) | 0.003 |
| H2O2_Light | | | | | | |

We observed that the coordination number changed from ˜4 to ˜5 and then back to ˜4 during the cascade photocatalysis, which is also confirmed by the DFT calculations. The Fe—N bond length is as high as ˜2.02 Å, in agreement with the fitting results for synchrotron soft X-ray spectroscopy characterization in Table 4.

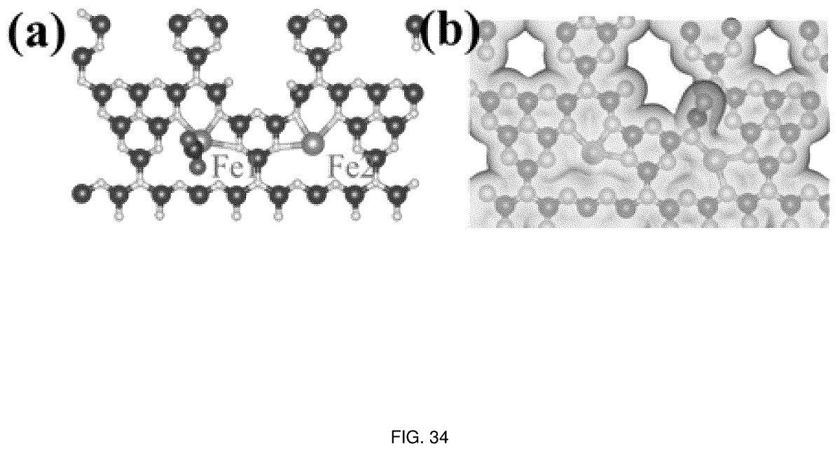

DFT calculations were performed to determine the role of Fe and carbon vacancy on acetic acid production based on the photocatalysis of Fe@C₃N₄ SAC. FIG. 34 depicts (a) the atomic configurations of Fe@C₃N₄ SAC and (b) its electronic potential distribution.

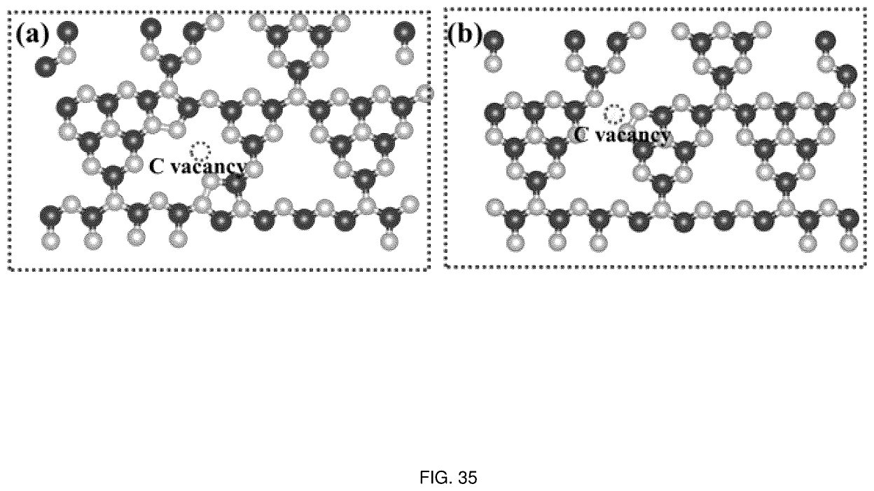

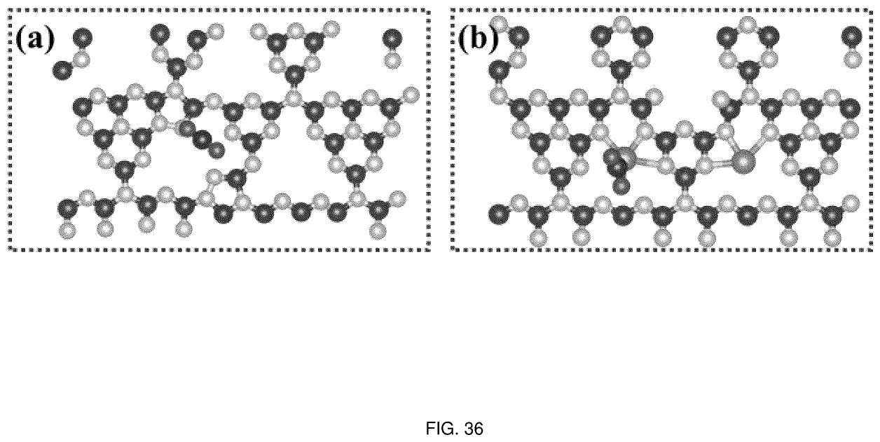

The Raman spectra confirmed the existence of defects in the C₃N₄ and Fe@C₃N₄ SAC (FIG. 34A). Thus, we first evaluated the carbon defect energy of C₃N₄ for a thermodynamically stable structure. The defect energy for carbon vacancy was 1.7 and 2.8 eV, respectively, for C₃N₄ and Fe@C₃N₄ SAC in thermodynamically stable structures (FIGS. 35A-B). Further, we determined the adsorption energy of CO₂ on Fe@C₃N₄ SAC and C₃N₄ to be −0.7 and −3.5 eV, respectively (FIGS. 36A-B). The strong adsorption of CO₂ on C₃N₄ was not favorable for the further transformation of CO₂ to *COOH.

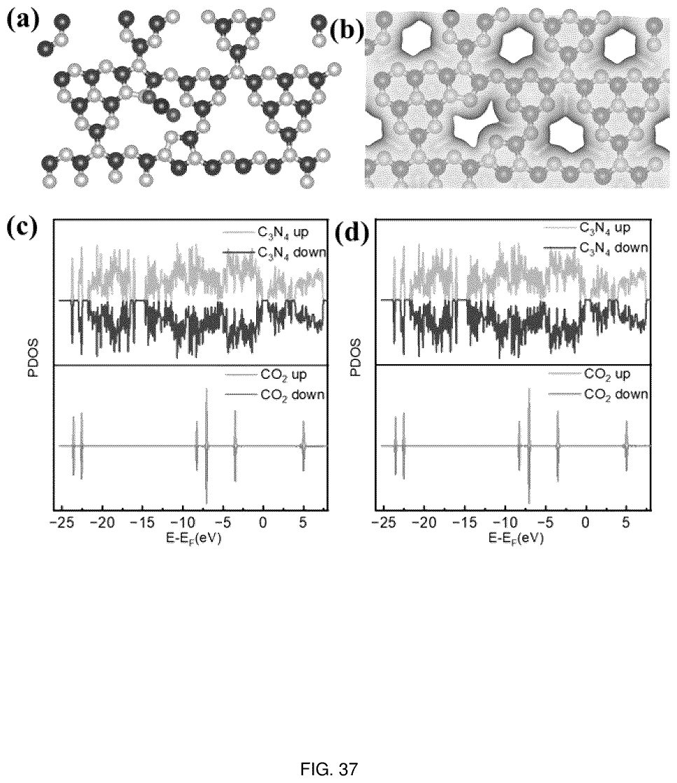

FIG. 37 depicts (a) Atomic configurations of C₃N₄ and (b) its electronic potential distribution. Projected density of states (PDOS) of Fe and CO₂ (c) before and (d) after the adsorption of CO₂ on the Fe1 site of C₃N₄. Based on the analysis of projected density of states (PDOS), CO₂ bands were seldom changed before and after its adsorption on C₃N₄ (FIGS. 37C-D), revealing that the Van der Waals force was vital in facilitating the adsorption of CO₂ on carbon-vacancy C₃N₄, rather than strong chemical bonds. In sharp contrast, Fe single atom sites in Fe@C₃N₄ SAC were the electron center, beneficial to adsorb CO₂ (FIG. 34B) and form strong chemical bonds for the activation of CO₂. After CO₂ adsorption on Fe@C₃N₄ SAC, the energy level of Fe from −10 to +4 eV overlapped with that of CO₂ (FIG. 31B), meaning Fe1 has an interaction with CO₂ via robust chemical bonds. In comparison with that before adsorption (FIG. 31A-B), the energy level of Fe1 slightly descended and the counterpart of CO₂ rose up, revealing that an electron was transferred from Fe1 to CO₂ and thus CO₂ was activated. Due to the high spin state of Fe in Fe@C₃N₄ SAC, the spin-up Fe shows a non-negligible gap between its energy peak and the Fermi level, thus posing a difficulty in transferring electrons between Fe sites and CO₂ (mainly energy overlap). Though spin-down Fe shows a negligible energy overlap with CO₂ (low interaction), it crosses the Fermi level, thus facilitating electron transfer from the spin-down to spin-up state (in the inset of FIG. 31A). In other words, the asymmetrical distribution of electrons, especially near the Fermi level, lowers the electron scattering from spin-up and spin-down states, thus accelerating electron transfer and promoting the fast transformation of CO₂ into other key intermediates.

In contrast, C₃N₄ needs extra energy to proceed for other key intermediates (FIG. 30 and FIGS. 37C-D). Further, a weaker adsorption energy of CO₂ on Fe@C₃N₄ SAC effectively promoted the transformation of CO₂ into other key intermediates. In addition, the cascade photocatalysis reaction pathway of the Fenton reaction and CO₂ reduction reaction to acetic acid were calculated.

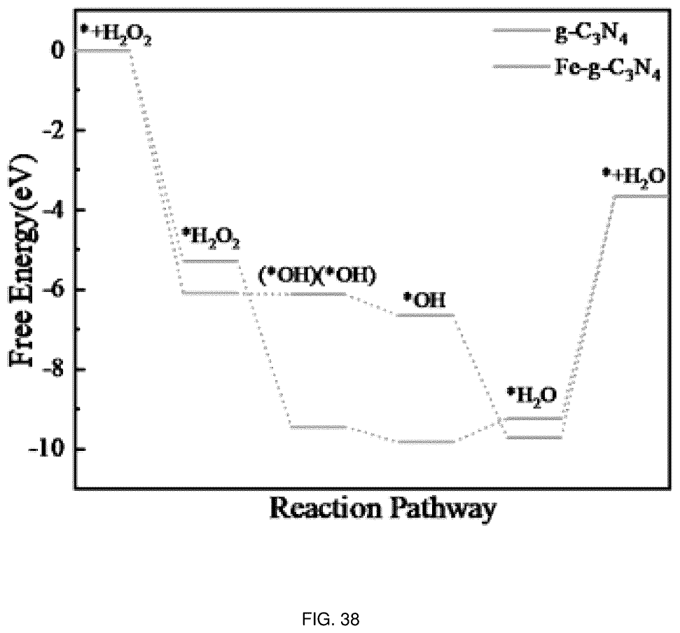

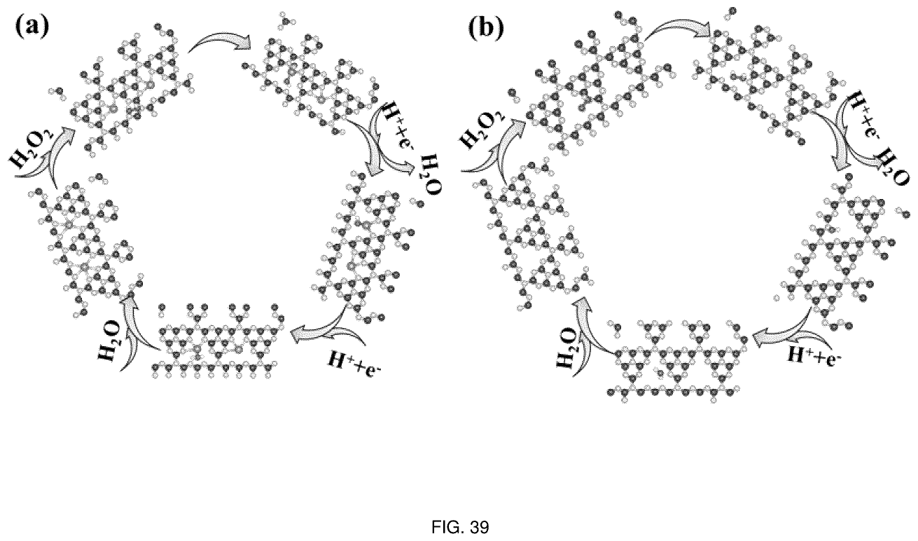

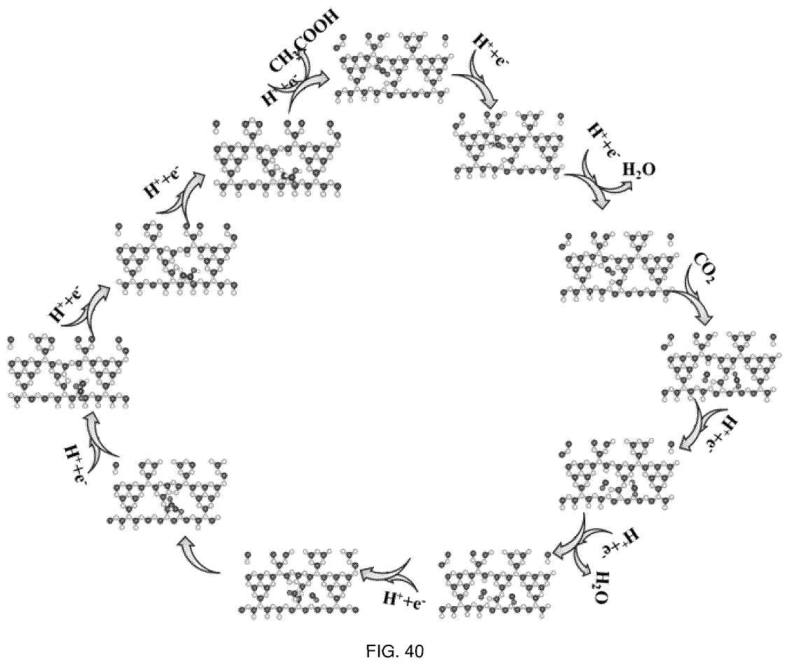

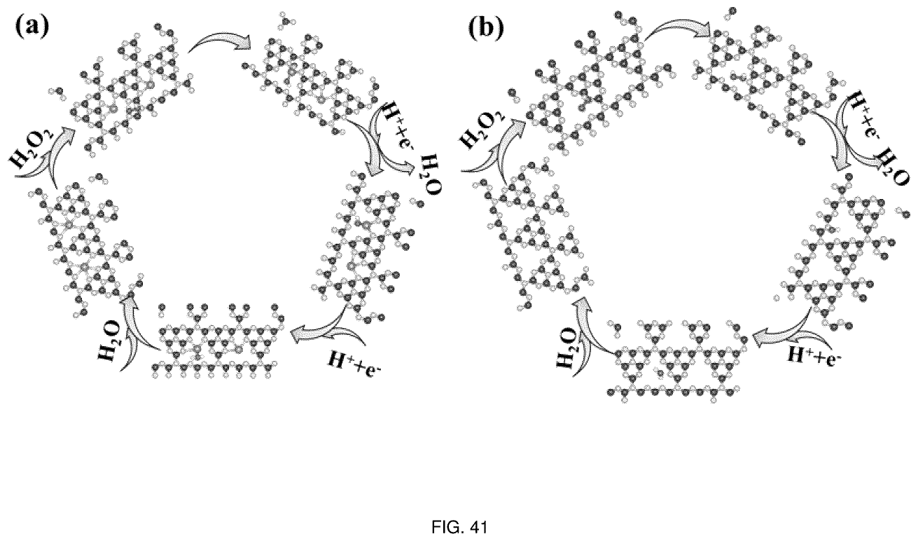

FIG. 38 shows the calculated Gibbs free energy diagram of the Fenton reaction pathway and FIG. 39 shows the Fenton reaction pathway of (a) Fe@C₃N₄ SAC and (b) C₃N₄. Based on the proposed Fenton reaction pathway (FIG. 38, FIG. 39), it was found that the free energy of *OH was the lowest among the intermediates on Fe@C₃N₄ SAC, thus leading to increased accumulation of *OH on Fe@C₃N₄ SAC. An estimated barrier of ˜0.6 eV was needed for the transformation of *OH into *H₂O. As expected, these accumulated *OH radical species promoted plastics oxidation into CO₂ intermediates on Fe@C₃N₄ SAC. In comparison, the most stable structure among the proposed radical structures on C₃N₄ was *H₂O, leading to increased consumption of adsorbed *OH. We also simulated the reaction pathway of CO₂ intermediates to acetic acid on Fe@C₃N₄ SAC and C₃N₄. Regardless of the role of Fenton reaction on the CO₂ reduction reaction, the estimated barriers were 0.94 and 2.47 eV, respectively, for Fe@C₃N₄ SAC and C₃N₄ (in FIGS. 29-30 and FIGS. 40-41). Specifically, FIG. 40 shows the calculated reaction pathway of C₃N₄ for CO₂ reduction reaction and FIG. 41 shows (a) the calculated Gibbs free energy diagram of CO₂ reduction reaction pathway for Fe@C₃N₄ and C₃N₄ with (b-c) their reaction pathway.

The rate-determined step on Fe@C₃N₄ SAC was the transformation of (*CO)(*CO) into (*CO)(*CHO) (FIG. 30). By contrast, CO₂ adsorption on C₃N₄ due to the Van der Waals force was not favorable for further CO₂ adsorption, and thus the rate-determined step on C₃N₄ was the transformation of *CO into (*CO)(*CO₂) (FIG. 30). Hence, in this study, the Fe single atoms and carbon vacancy were indeed the key to modulate the local electronic structure for cascade Fenton and CO₂ reduction reactions on the same catalyst.

### Methods

Materials: Melamine (C₃H₆N₆, 99%), iron (III) chloride hexahydrate (FeCl₃·6H₂O, ACS reagent, 97%), hydrogen peroxide solution (H₂O₂, 30% (w/w) in H₂O, contains stabilizer), polyethylene terephthalate (PET, size: 0.25 cm×0.35 cm×0.35 cm), polypropylene (PP, isotactic, average Mw ˜12,000, average Mn ˜5,000, size: 0.6 cm×0.7 cm×0.25 cm) and polyethylene (PE, average Mw ˜4,000 by GPC, average Mn ˜1,700 by GPC, size: between 5 μm and 800 um). All chemical reagents were used without further purification.

### Material Characterization

Scanning electron microscopy (SEM) images were tested with a working accelerating voltage of 10 kV. Glancing-incidence X-ray diffraction (GIXRD) results were collected using a diffractometer with Cu Kα radiation (1.54 Å) at an incidence angle of 1°. X-ray photoelectron spectroscopy (XPS) measurements were acquired from a microprobe with a monochromatic Al Kα X-ray source (1486.6 eV). The obtained spectra were calibrated using C is line. Probe aberration-corrected scanning transmission electron microscope (AC-STEM) tests were carried out on a TEM equipped with energy-dispersive X-ray spectroscopy (EDS) at 200 kV. The HAADF-STEM images were recorded by STEM with a probe aberration corrector operating at 200 kV. Inductively coupled plasma mass spectrometry (ICP-MS) analyses for Fe content were carried out on a triple quadrupole ICP-MS, using He as a collision cell gas and Sc as an internal standard to correct for instrument drift to obtain a primary ICP calibration standard. A secondary standard was used to confirm instrument accuracy (within 7%; relative standard deviation for individual sample analyses was <1.1%). Raman spectroscopy was collected to analyze the degree of graphitization and defects of the sample using the excitation wavelength of 785 nm. The laser beam was focused onto the sample's surface by an L×50 objective. The aperture is 50×1000 um and the resolution is 3-5 cm⁻¹. Each spectrum was integrated over 0.01 s at 50 mW laser power. At least 10 spectra in the range of 40-1520 cm⁻¹ were collected from randomly selected points on the surface of each sample.

### H-NMR Spectroscopy Measurement

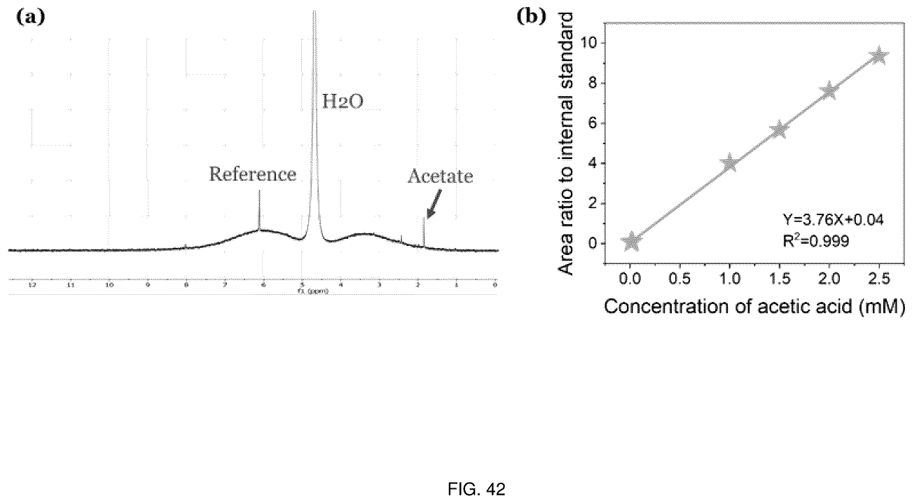

Proton nuclear magnetic resonance (H-NMR) was measured. A standard curve of acetic acid was firstly built using pure chemicals with known concentrations. NMR testing samples were prepared by combining 80 μL of aqueous 0.5 mg/mL maleic acid internal standard with 600 μL sample. After photocatalytic reaction, the solution was collected and mixed with the internal standard solution. The solutions are mixed in the same proportions as above. For H-NMR tests, 128 scans were performed, with excitation sculpting used to suppress the water peak. As presented in FIG. 42, acetate and maleic acid can be ascribed to the peaks located at 1.8 (triplet), and 6.1 ppm, respectively.

The concentration of liquid products could be calculated by the following equation:

$$Area ratio to maleic acid = 3.76 \times Concentration ( mM ) + 0.04$$

### Operando UV-Vis Spectroscopy Measurement

Irradiation of well-dispersed catalysts solution and salicylic acid (SA) mixtures was performed in the reactor. The solution was collected at certain time intervals (minutes) and the concentration of —OH radicals was determined from UV-Vis spectra acquired between 200 nm and 800 nm using a spectrophotometer.

### Operando Electron Paramagnetic Resonance (EPR) Spectroscopy Measurement

In situ EPR spectra were recorded on an EPR spectrometer at room temperature. Hydroxyl radicals (*OH) were captured using 5,5-dimethyl-1-pyrroline N-oxide (DMPO). In typical measurements, a well-dispersed catalysts solution was prepared followed by the addition of DMPO. The concentration of DMPO is 0.14 M in the final solution. EPR spectra were recorded before the irradiation. After 10 min irradiation on the solution in simulated natural environments under AM1.5G irradiation, the solution was analyzed a second time.

### Ex Situ Synchrotron Based X-Ray Absorption Spectroscopy (XAS)

Ex situ hard XAS measurements were carried out at the 20-BM and 20-ID-C beamline. The measurements at the Fe K-edge were performed in fluorescence mode using a Lytle detector. Ex situ Fe K-edge XAS measurements were also carried out in fluorescence mode at soft X-ray micro characterization beamline (SXRMB). The XAS data fitting for the first coordination shell was performed using the Artemis implemented in the FEFF software packages. The k and R ranges for fitting results were k=0-12 Å⁻¹ and R=1-3 Å, respectively and were used throughout the study. Values for the amplitude reduction factor was determined to be 0.8 from the Fe foil reference spectra, which was applied to the whole analysis. Fitting parameters were the coordination numbers (CN), the inner potential correction (AE), Debye-Waller factors (a²), atomic distances (R-factor). The quality of fitting results was assessed by the R-factor. R-factor Numbers less than or equal to 0.02 are considered acceptable.

### Operando XAS Measurements

The measurements were conducted at 061D-1 Hard X-ray MicroAnalysis (HXMA) beamline, operated at 2.9 GeV with a constant current of 250 mA. The operando measurements at the Fe K-edge were performed in fluorescence mode using a Lytle detector. The XAS data fitting for the first coordination shell was performed using the Artemis implemented in the FEFF software packages.

### Operando FTIR Measurements

The Measurements were conducted at 02B1-1 Far-IR beamline. Using a Bruker IFS125HR spectrometer equipped with a modified GladiATR diamond Attenuated Total Reflectance system. The 2 mL of a 1 mg/mL catalyst solution, 20 mg of PET and H₂O₂ was placed on the ATR diamond. Subsequently, the mixture was pressed by quartz window to ensure good contact between the ATR diamond and the catalysts/plastic powder. The data prior to illumination and the data collected every 20 minutes post-illumination were gathered.

### DFT Computational Details

Density functional theory (DFT) calculations were performed in the Vienna ab initio simulation package (VASP). The generalized gradient approximation with the Perdew-Burke-Emzerhof parameterization was used to approximate the exchange-correlation functional. The electron-ion interactions were described by the projector augmented wave (PAW) method. A plane-wave basis with the cutoff energy of 400 eV was used. The Brillouin zone was built using a 1×2×1 Gamma grid. The geometries got convergence until the energy of 1.0×10⁻⁵ eV/atom and the force of 0.05 eV/A. Van der Waals with DFT-D3 was considered in these simulations. A vacuum layer of 15 Å along the z direction was constructed to avoid periodic interaction.

To determine the carbon defect sites, the defect energy (Ed) was calculated as the following:

$${E}_{d} = {E}_{defect} + {E}_{C} - {E}_{prefect}$$

Wherein, E_{detect} was the energy of defect model, E_{c} was the energy of single carbon atom from bulk carbon, E_{prefect} was the energy of ideal model. A lower defect energy corresponds to higher stability.

To compare the adsorption of CO₂ on the substrates, the adsorption energy (E_{ads}) was evaluated as follows:

$${E}_{ads} = {E}_{total} - {E}_{gas} - {E}_{sub}$$

Wherein, Eₜₒₜₐₗ was the energy of gas adsorbed on the substrates, E_{gas} was the energy of CO₂, E_{sub} was the energy of the substrates. A more negative adsorption energy meant a more stable adsorption.

Gibbs free energy, presented by Nørskov et al, was calculated according to the following equation:

$$Δ G = Δ E + Δ ZPE - T Δ S$$

Wherein, ΔE was the electronic adsorption energy, ΔZPE was the zero point energy difference between the adsorption and gaseous species, and TΔS was the corresponding entropy difference between these two states. The free energy of H₂O in bulk water was calculated under the equilibrium vapor pressure (0.035 bar and 298.15K). The free energy of (H⁺+e⁻) was evaluated as the energy of ½ H₂ at standard conditions (1 bar and 298.15K).

As described herein, a strategy to upcycling plastics via photocatalysis was demonstrated and excellent production rates of acetic acid were observed. Plastic products were converted into CO₂ as intermediates firstly, then successfully converted into acetic acid on the same photocatalyst via cascade reactions without the addition of other sacrifices. In conclusion, this work not only demonstrates a photocatalytic process for remediating plastic waste in a simulated natural environment but also shows the possibilities of single-atom catalysts in plastic upcycling. The efficiency of photocatalysts to convert plastic waste into high-value chemicals can be further enhanced by application of photon transport and light trapping strategies as part of the reactor design.

This reaction mechanism was confirmed by in situ synchrotron X-ray absorption spectroscopy (XAS), in-situ Fourier transform infrared (FTIR) spectroscopy, in situ electron paramagnetic resonance (EPR), in situ UV-vis-absorption spectroscopy, Raman spectroscopy, and aberration-corrected scanning transmission electron microscopy, nuclear magnetic resonance spectroscopy, and density functional theory calculations. A state-of-art CH₃COOH production yield of 12.7 mg h⁻¹ g_{cat}⁻¹ from PE, 5.4 mg h⁻¹ g_{cat}⁻¹ from PET, and 5.3 mg h⁻¹ g_{cat}⁻¹ from PP were one-step directly obtained under AM1.5G solar irradiation, using a low-cost Fe@C₃N₄ SAC photocatalyst in a sealed reactor by enhancing the photon transport and utilization efficiency.

The scope of the claims should not be limited by the embodiments set forth in the above examples but should be given the broadest interpretation consistent with the description as a whole.

1. A method for plastic waste upcycling comprising:
providing plastic waste to be upcycled;
applying an iron (Fe) single-atom catalyst to the plastic waste to be upcycled; and
catalyzing, using the Fe single-atom catalyst, a reaction to upcycle the plastic waste to produce acetic acid.

2. The method of claim 1, wherein the plastic waste comprises one or more of polyethylene terephthalate (PET), polypropylene (PP) and polyethylene (PE), and PET with 30% glass fibers.

3. The method of claim 1, wherein the Fe single-atom catalyst comprises Fe atoms embedded on a graphitic carbon nitride (C₃N₄) support framework (Fe@C₃N₄ SAC).

4. The method of claim 3, wherein the mass ratio of iron in the Fe@C₃N₄ SAC is less than 1 wt. %.

5. The method of claim 4, wherein the mass ratio of iron in the Fe@C₃N₄ SAC is less than 0.5 wt. %.

6. The method of claim 3, further comprising synthesizing the Fe@C₃N₄ SAC by:
providing a melamine solution comprising 2 g of melamine dispersed in water;
providing a FeCl₃·6H₂O solution comprising 20 mg FeCl₃ dispersed in water;
mixing the melamine and the FeCl₃·6H₂O solutions together;
evaporating the water in the mixed solution to obtain a sample; and
calcining the sample at 550° C. to form the Fe@C₃N₄ SAC.

7. The method of claim 1, further comprising applying hydrogen peroxide to the plastic waste to be upcycled.

8. The method of claim 7, wherein catalyzing the reaction comprises:
catalyzing, by the Fe single-atom catalyst, decomposition of the hydrogen peroxide into hydroxyl radicals;
attacking, by the hydroxyl radicals, to oxidize the plastic waste into carbon dioxide intermediates; and
catalyzing, by the Fe single-atom catalyst, reduction of the carbon dioxide intermediates into acetic acid.

9. The method of claim 1, wherein catalyzing the reaction further comprises applying light to induce the reaction.

10. The method of claim 9, wherein the light is applied at an intensity of approximately 100 mW cm⁻².

11. The method of claim 9, further comprising sealing a reaction chamber to maintain the applied light in the reaction chamber to induce the reaction.

12. The method of claim 1, comprising obtaining a yield of the acetic acid of about 2 to about 5 mg h⁻¹ g_{cat}⁻¹.

13. The method of claim 12, comprising obtaining a yield of the acetic acid of about 3 mg h⁻¹ g_{cat}⁻¹.

14. Use of an iron (Fe) single-atom catalyst to photo-catalyze a reaction to upcycle plastic waste to produce acetic acid.

15. The use of the claim 14, wherein the Fe single-atom catalyst comprises Fe atoms embedded on a graphitic carbon nitride (C₃N₄) support framework (Fe@C₃N₄ SAC).

16. A catalyst to upcycle plastic waste in a photocatalytic reaction to produce acetic acid, comprising iron (Fe) atoms embedded on a graphitic carbon nitride (C₃N₄) support framework (Fe@C₃N₄ SAC).

17. The catalyst of claim 16, wherein the mass ratio of iron in the Fe@C₃N₄ SAC is less than 0.5 wt. %.
